(19) United States
(12) Patent Application Publication
(10) Pub. No.: US 2024/0244617 A1
(43) Pub. Date: Jul. 18, 2024

(54) PRE-CONFIGURED ALLOCATION WITH MULTIPLE TRAFFIC TYPES

(71) Applicant: Telefonaktiebolaget LM Ericsson (publ), Stockholm (SE)

(72) Inventors: Bikramjit Singh, Raasepori (FI); Massimo Condoluci, Sundbyberg (SE)

(21) Appl. No.: 18/560,140

(22) PCT Filed: May 11, 2021
(86) PCT No.: PCT/SE2021/050447

§ 371 Date: Nov. 10, 2023

(51) Int. Cl. H04W 72/1268; H04W 72/21

(52) U.S. Cl. CPC H04W 72/1268; H04W 72/21

(57) ABSTRACT

A method by a wireless device for using an allocation of resources for transmission of multiple traffic types includes receiving, from a network node, a first allocation of at least one resource for transmission of data associated with a plurality of traffic types in a first transmission occasion. Based on the first allocation, the wireless device transmits, to the network node, the data associated with the plurality of traffic types in the first transmission occasion.

### TECHNICAL FIELD

The present disclosure relates, in general, to wireless communications and, more particularly, systems and methods for pre-configured allocation of transmission resources for multiple traffic types.

### BACKGROUND

User plane latency control plays a crucial role in meeting end-to-end (E2E) service delay requirements in today and future wireless communication network. More and more newly emerging services and applications require very stringent E2E delay requirements. In a typical cellular network, such as Long Term Evolution (LTE) and New Radio (NR), it is the scheduler that determines when and to/from which devices to perform a data transmission, therefore the scheduler practically dictates the time delay. The scheduler can be operated in various modes to meet different time delay requirements.

Dynamic scheduling is a basic and primary mode where each scheduled transmission time interval (TTI), e.g. slot, the scheduler provides a signaling grant to devices instructing when and what transport format to use for the coming data transmission. The scheduler issues the grant once it gets knowledge of a device with data to transmit through, e.g. buffer status report (BSR), or as a minimum of one-bit flag scheduling request (SR). The scheduling request loop refers to the case when the device has no valid grant but has data arrival at its buffer and starts with an SR on public resources (PUCCH), and the scheduler issues a grant for BSR and until the devices get a valid grant for data transmission. Existence of the SR loop could adversely impact latency, especially for those service where small amount but frequent delay-sensitive data need to be transmitted in uplink, e.g. online game, ping etc.

Prescheduling addresses this issue by predictively sending a predefined default grant to devices with no need for knowledge of the devices buffer status. On reception of the grant, the devices may utilize the granted resources to transmit data directly and/or report buffer status depending on how much payload data can be transmitted by the grant. In case of no data awaiting in buffer, the device may skip over the grant and transmit nothing.

A configured grant transmission, which may also be called a grant free transmission, is proposed as an alternative approach not relying on dynamic grants. The basic idea is to configure a predefined grant to a device, and it may be used when data arrives at the UE buffer but no dynamic grant is available. As like prescheduling, configured grant is also predictive. It provides a predictive default grant capable of transmitting any low latency data.

Typically, period and data size are two core parameters configured for a predictive grant. Period is how often the grant is issued and data size determines the payload size of an uplink transmission. Configuration of these two parameters is usually a tradeoff between latency need and resource utilization.

Data size needs to be determined judiciously. If the data size is too big, the data consumes resources very quickly as the number of devices increases. If the data size is too small, the transmission may cause buffer data segmentation and, thus, result in longer latency. In practice, a Configured Grant (CG) is configured conservatively, i.e., reasonably small data size targeted to allow BSR or single ping packet transmission.

The trend is more dynamics in the sense of delay control will be posed to radio access network. One dynamic comes from variation in traffic behavior. The requirement of better support for different types of delay-sensitive services increases likelihood of diversified traffic behavior. To have prescheduling parameters adaptive to service type will give more gain. Dynamic Time Division Duplexing (TDD) where the scheduler dynamically determines the transmission direction, i.e., uplink or downlink, creates another type of dynamics. In contrast to a static TDD pattern where uplink and downlink slots are statically determined, the time duration in dynamic TDD between two neighboring uplink slots could be varying from frame to frame. It is then beneficial to have prescheduling/configured grant type of periodic scheduling aware of this type of dynamics and adjust its configuration parameters accordingly.

### Uplink (UL) Configured Grant (CG)

In NR, configured scheduling is used to allocate semi-static periodic assignments or grants for a user equipment (UE). For uplink, there are two types of configured scheduling schemes: Type 1 and Type 2. For Type 1, configured grants are configured via Radio Resource Control (RRC) signaling only. For Type 2, similar configuration procedure as Semi-Persistent Scheduling (SPS) uplink (UL) in LTE was defined, i.e. some parameters are preconfigured via RRC signaling and some physical layer parameters are configured via Medium Access Control (MAC) scheduling procedure. The detail procedures can be found in 3GPP TS 38.321 clause 5.8.2.

Similar to SPS in LTE, the CG periodicity is RRC configured, and this is specified in the ConfiguredGrantConfig Information Element (IE). Different periodicity values are supported in NR depending on the subcarrier spacing. For example, for 15 and 30 kHz Subcarrier spacing (SCS), the following periodicities are supported, expressed in a number of Orthogonal Frequency Division Multiplexing (OFDM) symbols:
15 kHz SCS
   2, 7, and n*14 OFDM symbols
   where n∈{1, 2, 4, 5, 8, 10, 16, 20, 32, 40, 64, 80, 128, 160, 320, 640}
30 KHz SCS
   2, 7, and n*14 OFDM symbols
   where n∈{1, 2, 4, 5, 8, 10, 16, 20, 32, 40, 64, 80, 128, 160, 256, 320, 640, 1280}

For Type1 configured grants, in addition to the periodicity, the time domain allocation of Physical Uplink Shared Channel (PUSCH) is configured purely via RRC signalling:
timeDomainOffset: Provides a slot offset with respect to system frame number (SFN) 0
timeDomainAllocation: Provides an index into a table of 16 possible combinations of PUSCH mapping type (TypeA or TypeB), start symbol S for the mapping (S=OFDM symbol 0, 2, 4, or 8 within a slot), and length L of the mapping (L=4, 6, 8, 10, 12, or 14 OFDM symbols).

For the case of Type2 configured grants, the periodicity is configured by RRC in the same way as for Type1, but the slot offset is dynamically indicated and is given by the slot in which the UE receives the DCI that activates the Type2 configured grant. In contrast to Type1, the time domain allocation of PUSCH is indicated dynamically by DCI via the time domain resource assignment field in the same way as for scheduled (non-CG) PUSCH. This DCI field indexes a table of start symbol and length (SLIV) values.

A configuredGrantTimer (CGT) is introduced to prevent both of the following cases to occur
1) a configured grant to override a transport block (TB) scheduled with a dynamic grant (i.e., new transmission or retransmission)
2) a configured grant to override an initial TB with another configured grant (i.e., new transmission)

Meanwhile, there is no explicit Hybrid Automatic Repeat Request Acknowledgement/Non-acknowledgement (HARQ A/N) in Rel-15. The gNB signals a grant indicating a new transmission to the UE which can inexplicitly indicate an acknowledgement or “ACK”.

The CGT is started/restarted for a HARQ process which is configured for a configured grant, upon transmission on PUSCH with a dynamic grant (i.e., new transmission or retransmission) or a configured grant (i.e., new transmission). It is stopped when either of below cases occur
1) the UE has received a PDCCH indicating configured grant Type 2 activation.
2) the corresponding HARQ process has been ACKed (i.e., a grant indicating a new transmission for the associated HARQ process) Its expiration means ACK for the associated HARQ process.

The detailed configuration details of the RRC specification for configured grant in NR Rel-16 is discussed in 3GPP TS 38.331.

As compared to the Configured grant in NR Rel-15 specifications, in Rel-16, a UE can trigger a retransmission autonomously using a configured grant for a HARQ process configured with autonomous uplink (AUL) when the CG retransmission timer is expired while the UE has not received HARQ feedback for the HARQ process. A timer “CG retransmission timer (CGRT)” is defined accordingly. This timer is configured by the RRC parameter cg-RetransmissionTimer in the ConfiguredGrantConfig. The CGRT is started for a HARQ process configured with AUL upon the data transmission using a configured grant, and a retransmission using another configured grant is triggered when the CGRT expires.

With this added functionality, it is beneficial for the UE to avoid the HARQ process to be stalled in case the gNB has missed the HARQ transmission initiated by the UE. However, an issue may be that a UE may just continuously initiate autonomous HARQ retransmissions for a HARQ process for a very long time. However, the gNB may not successfully receive the TB either due to bad radio channel quality or because the channel is seldom obtained due to LBT failures. This is certainly not desirable because the packet may become too old and any retransmission attempt would just further congest the channel and further affect the latency of other packets in the UL buffer.

The Radio Link Control (RLC) layer at the UE may sooner or later trigger RLC retransmissions for a RLC Packet Data Unit (PDU) which is still under retransmissions in the HARQ. The retransmitted RLC PDU would occupy a different HARQ process. In this case, the UE would then maintain two HARQ processes in transmission for the same RLC PDU. The RLC receiver at the gNB may receive two RLC PDU duplicates. This may create a trouble in case a wraparound of the RLC sequence number occurs. The second received RLC PDU may be treated as a new data and forwarded upward instead the PDU should be dropped.

Therefore, it is necessary to introduce a maximum limit on AUL retransmissions of a HARQ process triggered by a UE. To address this issue, a timer is configured to indicate the maximum amount of time for the UE to complete transmission of an HARQ process. When the timer expires, the UE should flush the HARQ buffer for this HARQ process and transmit new data associated to it. It has been agreed to use an existing timer configuredGrantTimer (CGT) for this purpose. If both CGT and CG retransmission timer (CGRT) are configured for a HARQ process, both timers can be operated in parallel. In this way, the UE can perform HARQ retransmission using CG resources for a HARQ process while CGT is running for the process. The value of CGT should be longer than that of CG retransmission timer. The HARQ buffer is flushed at expiry of CGT. FIG. 1 illustrates an example of the procedure for controlling maximum number of AUL retransmissions using CGT.

A UE can be provided with multiple active configured grants for a given BWP in a serving cell. The introduction of multiple configured grants would serve at least for enhancing reliability and reducing latency of critical services. In addition, it is also being discussed to apply multiple configured grants for allowing the UE to switch to slot-based transmissions after initiating the channel occupancy time (COT) to minimize Demodulation Reference Signal (DMRS) and UCI overhead in unlicensed spectrum.

For each CG configuration, there are a number of HARQ processes in the HARQ process pool assigned. There is also a separate CGT timer and CGRT setting associated with each CG configuration. It is allowed to share HARQ processes between CG configurations, which can give better configuration flexibility. In addition, if each CG configuration has separate associated HARQ processes, the HARQ process space may become limited for the UE.

Since a logical channel (LCH) can be mapped to multiple CG configurations, meaning the UE can transmit the data of the LCH using multiple active CG resources at the same time. For a TB which was transmitted using a CG resource, it is allowed to use any CG resource among the set of CG resources mapped to the LCH which comes earliest in the time to perform retransmission, this can reduce the latency. In addition, the selected resource shall provide same size as the same initial TB to avoid rate-matching on the TB. In addition, the UE shall stick to the same HARQ process for transmission/retransmission of a TB.

The CGT timer for a HARQ process shall be only started when the TB using this HARQ process is initially transmitted. The value of the CGT timer is set according to the CG configuration/resource which is used for the initial transmission. In parallel, the CGRT shall be started/restarted and set to the timer value which is used for every transmission/retransmission attempt. If the initial transmission of a TB uses the resource in CG configuration 1, the CGRT is started using the timer value configured in CG configuration 1. The next retransmission of the TB is performed with the resource in CG configuration 2. The CGRT need to be restarted and set to the timer value configured in CG configuration 2.

The HARQ process number field in the UL DCI (e.g., format 0-0 or format 0-1) scrambled by CS-RNTI is used to indicate which configuration is to be activated and which configuration(s) is/are to be released. In the DCI, the New Data Indication (NDI) in the received HARQ information is 0.

Upon reception of an activation/reactivation/deactivation command, the UE provides a confirmation MAC control element (CE) to the gNB. The MAC CE contains a bitmap of CG configurations. In the bitmap field, each bit corresponds to a specific CG configuration (i.e., the bit position corresponds to the CG index)

CG with Repetition

Repetition of a TB is also supported in NR, and the same resource configuration is used for K repetitions for a TB including the initial transmission. The higher layer configured parameters repK and repK-RV define the K repetitions to be applied to the transmitted transport block, and the redundancy version pattern to be applied to the repetitions. For the nth transmission occasion among K repetitions, n=1, 2, . . . , K, it is associated with (mod(n−1,4)+1)th value in the configured Redundancy Version (RV) sequence. The initial transmission of a transport block may start at
the first transmission occasion of the K repetitions if the configured RV sequence is {0,2,3,1},
any of the transmission occasions of the K repetitions that are associated with RV=0 if the configured RV sequence is {0,3,0,3},
any of the transmission occasions of the K repetitions if the configured RV sequence is {0,0,0,0}, except the last transmission occasion when K=8.

For any RV sequence, the repetitions shall be terminated after transmitting K repetitions, or at the last transmission occasion among the K repetitions within the period P, or when a UL grant for scheduling the same TB is received within the period P, whichever is reached first. The UE is not expected to be configured with the time duration for the transmission of K repetitions larger than the time duration derived by the periodicity P.

For both Type 1 and Type 2 PUSCH transmissions with a configured grant, when the UE is configured with repK>1, the UE shall repeat the TB across the repK consecutive slots applying the same symbol allocation in each slot. If the UE procedure for determining slot configuration, as defined in subclause 11.1 of 3GPP TS 38.213, determines symbols of a slot allocated for PUSCH as downlink symbols, the transmission on that slot is omitted for multi-slot PUSCH transmission.

### Downlink (DL) SPS

DL-SPS is a scheme similar to semipersistent scheduling in LTE. A semi-static scheduling pattern is signaled in advance to the device. Upon activation by L1/L2 control signaling, which also includes parameters such as the time-frequency resources and coding-and-modulation scheme to use, the device receives downlink data transmissions according to the preconfigured pattern. In the downlink, semi-persistent scheduling is supported where the device is configured with a periodicity of the data transmissions using RRC signaling. Activation of semi-persistent scheduling is done using the Physical Downlink Control Channel (PDCCH) as for dynamic scheduling but with the Configured Scheduling-Radio Network Temporary Identifier (CS-RNTI) instead of the normal Cell-Radio Network Temporary Identifier (C-RNTI). The PDCCH also carries the necessary information in terms of time-frequency resources and other parameters needed in a similar way as dynamic scheduling. The hybrid-ARQ process number is derived from the time when the downlink data transmission starts according to a formula. Upon activation of semi-persistent scheduling, the device receives downlink data transmission periodically according to the RRC-configured periodicity using the transmission parameters indicated on the PDCCH activating the transmission. Hence, control signaling is only used once and the overhead is reduced.

After enabling semi-persistent scheduling, the device continues to monitor the set of candidates PDCCHs for uplink and downlink scheduling commands. This is useful in the case that there are occasional transmissions of large amounts of data for which the semi-persistent allocation is not sufficient. It is also used to handle hybrid-ARQ retransmissions which are dynamically scheduled. FIG. 2 illustrates a DL SPS PDSCH transmission.

Certain problems exist. For example, targeting the support of low-latency traffic via pre-configured allocation, e.g., SPS/CG, a certain service would be assigned fixed-size resources periodically. This is because SPS/CG has been initially designed for fixed-size traffic with periodic inter-packet arrival time. But this is not the only type of traffic that requires bounded latency. For example, there are Extended Reality (XR) use cases which is a form of Ultra-reliable low-latency communication (URLLC) traffic with moderate bounded latency. XR traffic has fix period but data volume may vary in each period, and when applying the legacy SPS/CG mechanisms issues in terms of poor spectral efficiency raise, as there might be cases when XR service has lower amount of data to transfer compared to the available resource allocation.

To overcome this, the network could: (i) allocate a smaller resource, which is not optimal as when there will be more traffic, the service will experience higher latency as multiple transmission opportunities would be needed for data transfer; (ii) change configuration of SPS/CG dynamically to accommodate a variable resource size, with consequent issues in terms of overhead/signaling as the gNB would need to send a new DCI with the novel SPS/CG resource allocation. This is another problem where the current pre-configured allocations, i.e. SPS/CG is unable to cater. To summarize, the legacy SPS/CG has problems when applied to variable size traffic, where problems are in terms of poor spectrum utilization if fixed-size resource allocation is kept and in terms of higher overhead if variable size allocation is enabled.

Additionally, with pre-configured allocation, a given SPS/CG is assigned to carry traffic belonging to the same service. Considering the case of traffic patterns with variable size, this represents a problem as it limits multiplexing capabilities of scheduling algorithm unless high overhead/signaling is introduced to vary resource allocation size for each SPS/CG allocated to the different traffic types or services. This is itself a problem where in 5G we are already expecting the rise of multiple types of services which would either require or benefit from low-latency, and consequently having a single SPS/CG match might have implications in terms of overhead/signaling (each service requesting a separate SPS/CG, plus separate updates of SPS/CG configuration to accommodate traffic size changes). And of course, this would become a native aspect to be considered for B5G and 6G, where potentially there will be a multitude of services with heterogeneous traffic patterns (periodic/non-periodic, fixed/varying packet size, etc.) but with low latency needs for which SPS/CG could be a favorable option.

### SUMMARY

Certain aspects of the present disclosure and their embodiments may provide solutions to these or other challenges. For example, according to certain embodiments, methods and systems are provided that utilize a pre-configured allocation (SPS/CG) that provides transmission occasions for multiple traffic types (a.k.a. services). On each transmission occasion, data or transport blocks (TBs) from multiple traffic are transmitted. Further, an additional signaling mechanism is provided where gNB can send an update DCI to indicate the division of resources of the SPS/CG for certain transmission occasion(s) among different types of traffic, such as, for example, URLLC and eMBB. Additionally, in particular embodiments relating to UL transmission, an option may be that a UE can include UCI in CG transmission to indicate the division of resources among the traffics.

According to certain embodiments, a method by a wireless device for using an allocation of resources for transmission of multiple traffic types includes receiving, from a network node, a first allocation of at least one resource for transmission of data associated with a plurality of traffic types in a first transmission occasion. Based on the first allocation, the wireless device transmits, to the network node, the data associated with the plurality of traffic types in the first transmission occasion.

According to certain embodiments, a wireless device includes processing circuitry configured to receive, from a network node, a first allocation of at least one resource for transmission of data associated with a plurality of traffic types in a first transmission occasion. Based on the first allocation, the processing circuitry is configured to transmit, to the network node, the data associated with the plurality of traffic types in the first transmission occasion.

According to certain embodiments, a method by a network node for providing an allocation of resources for transmission of multiple traffic types by a wireless device includes transmitting, to the wireless device, a first allocation of at least one resource for transmission of data associated with a plurality of traffic types in a first transmission occasion. Based on the first allocation, the network node receives, from the wireless device, the data associated with the plurality of traffic types in the first transmission occasion.

According to certain embodiments, a network node includes processing circuitry configured to transmit, to the wireless device, a first allocation of at least one resource for transmission of data associated with a plurality of traffic types in a first transmission occasion. Based on the first allocation, the processing circuitry is configured to receive, from the wireless device, the data associated with the plurality of traffic types in the first transmission occasion.

According to certain embodiments, a method by a wireless device for using an allocation of resources for reception of multiple traffic types includes receiving, from a network node, a first allocation of at least one resource for transmission of data associated with a plurality of traffic types in a first transmission occasion. Based on the first allocation, the wireless device receives, from the network node, the data associated with the plurality of traffic types in the first transmission occasion.

According to certain embodiments, a wireless device includes processing circuitry configured to receive, from a network node, a first allocation of at least one resource for transmission of data associated with a plurality of traffic types in a first transmission occasion. Based on the first allocation, the processing circuitry is configured to receive, from the network node, the data associated with the plurality of traffic types in the first transmission occasion.

According to certain embodiments, a method by a network node for using an allocation of resources for transmission of multiple traffic types includes transmitting, to a wireless device, a first allocation of at least one resource for transmission of data associated with a plurality of traffic types in a first transmission occasion. Based on the first allocation, the network node transmits, to the wireless device, the data associated with the plurality of traffic types in the first transmission occasion.

According to certain embodiments, a network node includes processing circuitry configured to transmit, to a wireless device, a first allocation of at least one resource for transmission of data associated with a plurality of traffic types in a first transmission occasion. Based on the first allocation, the processing circuitry is configured to transmit, to the wireless device, the data associated with the plurality of traffic types in the first transmission occasion.

Certain embodiments may provide one or more of the following technical advantages. For example, one technical advantage may be that certain embodiments save PDCCH resources. Currently, each DCI enables grant to a service. Even though, a DCI can provide multi-TB allocation, the allocation belongs to the same traffic or service. However, when it comes to multi-service grant (dynamic or CG/SPS), it's currently only possible with separate DCIs. However, certain embodiments proposed here in are able to do at one time and thus able to save precious PDCCH resources.

As another example, a technical advantage may be that certain embodiments reduce PDCCH usage because, when the gNB updates the SPS/CG resource split among the traffics, only an update DCI may be sent. This update DCI is a light DCI compared to the previous DCIs since the update DCI carries only the information of how resources are to be split among the traffics, without the need to provide a new whole resource allocation.

As still another example, a technical advantage may be that certain embodiments simplify resource adaptation to the traffic in an easier way if a variable data such as XR traffic is served whose transmission period is fixed/known. Due to multiple traffic type or multi-service allocation over CG/SPS, each occasion can be packed with varying data size for XR services or other critical data/TB and the rest with full-buffer traffic, e.g., eMBB. By contrast, current techniques require separate grants for critical, e.g., XR, and for eMBB transmission.

As still another example, a technical advantage may be that certain embodiments reduce latency by leveraging on CG/SPS while supporting data size variation via a lighter DCI and/or an update DCI, which may allow data to be more quickly transmitted than those previously configured via legacy CG/SPS, because XR data is varying in size and typical CG has the drawback of fixed resource size so more latency is introduced in case data to be transmitted exceed the legacy CG/SPS size.

As still another example, a technical advantage may be that certain embodiments that reduce signaling also result in power saving as a byproduct. Since a UE is able to transmit different traffics on a single grant and also since DCI usage is reduced, power saving is an added advantage.

As still a further example, a technical advantage may be that certain embodiments allow to change the resource split to among high- and low-priority traffic enabling the low-priority traffic to use resources that are not necessary in a certain transmission occasion to higher-priority traffic. This may bring benefits in terms of improved spectral efficiency.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of the procedure for controlling maximum number of autonomous uplink (AUL) retransmissions using configuredGrantTimer (CGT);

FIG. 2 illustrates a downlink (DL) Semi-Persistent Scheduling (SPS) Physical Downlink Shared Channel (PDSCH) transmission;

FIG. 3 illustrates a transmission occasion in a period being allocated to multiple traffic types, according to certain embodiments;

FIG. 4 illustrates a UE including update UCI to indicate splitting of CG occasion for URLLC and eMBB usage, according to a particular embodiment;

FIG. 5 illustrates an example wireless network, according to certain embodiments;

FIG. 6 illustrates an example network node, according to certain embodiments;

FIG. 7 illustrates an example wireless device, according to certain embodiments;

FIG. 8 illustrate an example user equipment, according to certain embodiments;

FIG. 9 illustrates a virtualization environment in which functions implemented by some embodiments may be virtualized, according to certain embodiments;

FIG. 10 illustrates a telecommunication network connected via an intermediate network to a host computer, according to certain embodiments;

FIG. 11 illustrates a generalized block diagram of a host computer communicating via a base station with a user equipment over a partially wireless connection, according to certain embodiments;

FIG. 12 illustrates a method implemented in a communication system, according to one embodiment;

FIG. 13 illustrates another method implemented in a communication system, according to one embodiment;

FIG. 14 illustrates another method implemented in a communication system, according to one embodiment;

FIG. 15 illustrates another method implemented in a communication system, according to one embodiment;

FIG. 16 illustrates an example method by a wireless device, according to certain embodiments;

FIG. 17 illustrates an example virtual computing device, according to certain embodiments;

FIG. 18 illustrates an example method by a network node, according to certain embodiments;

FIG. 19 illustrates another example virtual computing device, according to certain embodiments;

FIG. 20 illustrates another example method by a wireless device, according to certain embodiments;

FIG. 21 illustrates another example virtual computing device, according to certain embodiments;

FIG. 22 illustrates another example method by a network node, according to certain embodiments; and

FIG. 23 illustrates another example virtual computing device, according to certain embodiments.

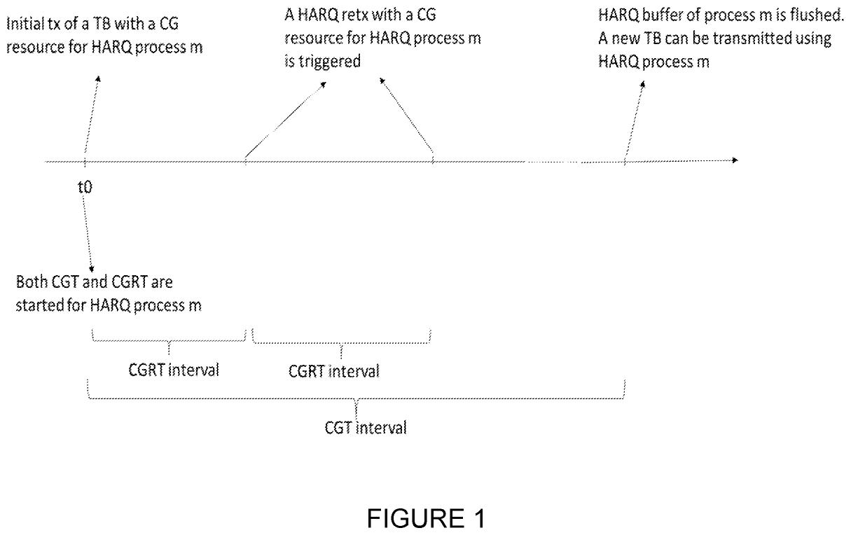

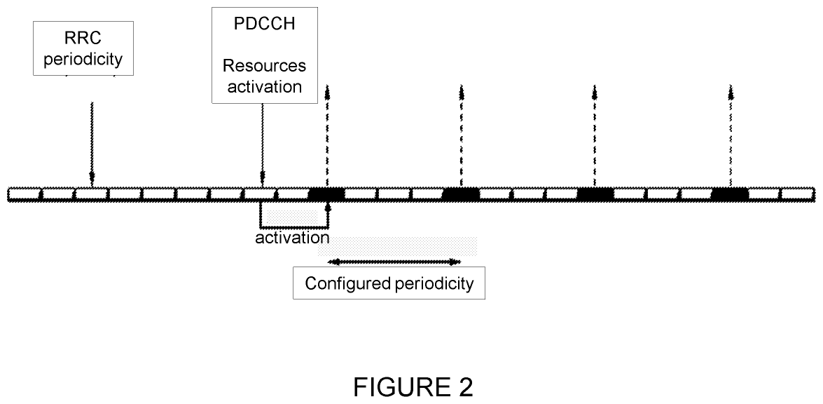

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. Evolved-Serving Mobile Location Center (E-SMLC)), Minimization of Drive Test (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services UE (ProSe UE), Vehicle to Vehicle (V2V) UE, Vehicle to Anything (V2X) UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

The term uplink Configured Grant (UL CG) is used herein with respect to some embodiments. However, embodiments, and techniques may be used for downlink Semi Persistent Scheduling (DL SPS) in DL direction unless and otherwise explicitly mentioned.

For the sake of simplicity, the term UL CG (or CG) is used herein to denote UL pre-configured periodic allocation. However, the proposed UL pre-configured resource/allocation is an enhanced version of previous CGs.

The preconfigured UL CG can be used in licensed or unlicensed spectrum, NR or NR-U spectrum, etc.

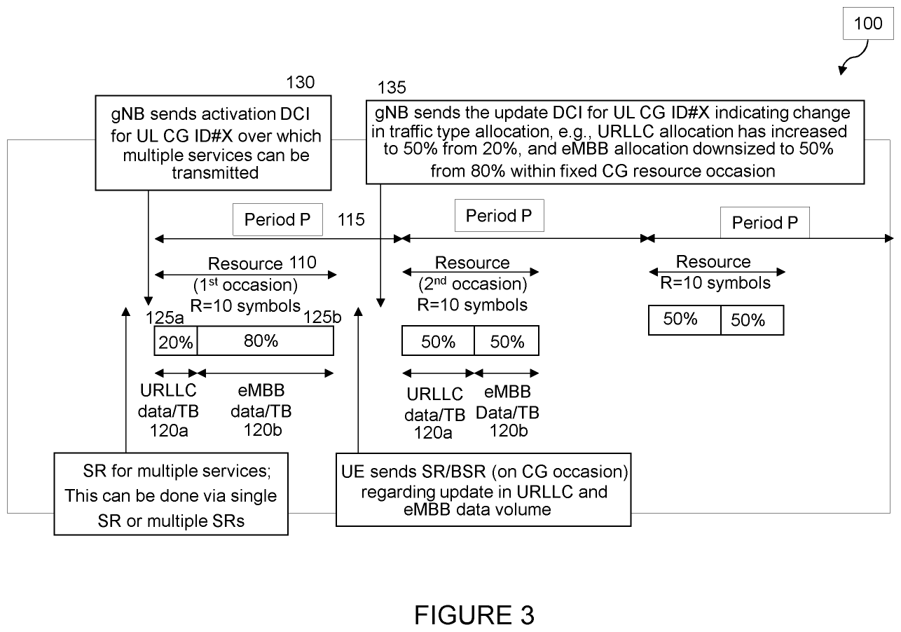

Previous systems for resource allocation allow for the allocation of a transmission occasion to only a single traffic type. However, according to certain embodiments disclosed herein, a transmission occasion associated with a CG may be allocated or distributed among multiple traffic types. FIG. 3 illustrates a scenario 100 where a transmission occasion (of resource size R) 110 in a period 115 is allocated to multiple traffic types. The multiple traffic types 120a-b may be associated with multiple services such as, for example, eMBB, URLLC, TSN, VOIP, etc. Specifically, FIG. 3 illustrates two different types of traffic, URLLC and eMBB, as being allocated to a single transmission occasion. It is noted that this particular example scenario is used throughout this disclosure. However, it is noted that FIG. 3 is provided as just one example. It may be recognized that a transmission occasion is not necessarily limited to only two traffic types 120a-b and that these traffic types may vary from URLLC and eMBB. For example, in another scenario, a first transmission occasion might be split between URLLC and eMBB, the second transmission occasion might be split between TSN and URLLC, and a third transmission occasion might be split between URLLC, TSN and eMBB, etc. Thus, any suitable number of traffic types may be allocated to a transmission occasion. In various particular embodiments, the different traffic types may be associated with different characteristics, different types or levels of priorities, and/or different types of traffic patterns.

Returning to FIG. 3, it is noted that the multiple traffic types are encoded into separate TBs 125a-b on in a transmission occasion, in a particular embodiment. For example, as illustrated in FIG. 3, URLLC TB 120a is transmitted over 20% of the resource in the first transmission occasion, and eMBB TB 120b is transmitted over 80% of the resource in the first transmission occasion. Where the first transmission occasion includes 10 symbols, URLCC TB 120a is allocated 2 OS and eMBB TB 120b is allocated 8 OS.

In various particular embodiments, the encoding parameters (MCS, RV, precoding parameters, repetitions, etc.) can be same or different for the these TBs.

In a particular embodiment, the multiple traffic types/streams or services can be differentiated with any one or more of the following non-limiting options:
different PHY priorities
different MAC (LCH/LCG) priorities
different traffic/data characteristics, e.g., different packet arrival periodicity, different packet size, traffic origin source
different application context, or different application source
different data/bit encoding, e.g., different MCS, bitrate
different QoS targets (e.g., different 5QIs, different bearer priority, different reliability, different latency budget, different time synch targets, different jitter target)
information provided from higher layers, for example fields or flags in the header identifying a certain type of traffic, or certain functionalities that should be applied to the traffic, etc.

In a particular embodiment, a gNB allows the change of resource usage among multiple traffic types 120a-b within one or more occasions. Thus, the resource division among traffic types within a first transmission occasion may be different from the resource division among the traffic types in another transmission occasion. For example, consider the depicted example of FIG. 3 with two traffic types, URLLC and eMBB. As depicted in the figure and noted above, in the first transmission occasion, URLLC traffic 120a are allocated with 20% of symbols (2 symbols) and eMBB traffic 120b are allocated with 80% of symbols (8 symbols) from total resource in the occasion, which in this example scenario is 10 symbols. This configuration is given by the CG provided by the first activation DCI 130. However, in the second transmission occasion, the resource usage among the traffic types 120a, 120b are changed, where both are updated to 50% (i.e. 5 symbols each for URLLC and eMBB traffic type). Note that, while not depicted, the resource division may include a split with 0% and 100% value or vice-versa such that the whole transmission occasion may be allocated to a single traffic type.

In a particular embodiment, the division of resources among the traffic types may change, but the overall resource may be fixed. For example, as depicted in FIG. 3, the overall resource per occasion remains fixed for each of the different occasions at R=10 symbols. Additionally, the Period, P, remains the same throughout.

In a particular embodiment, in order to change the resource division among the traffic types within an occasion, a gNB may send an update DCI 135 to indicate the change in the division of resources or to indicate a new division. Specifically, as depicted, the gNB may send the update DCI 135 after the first transmission occasion to indicate change in division of resources for URLLC and eMBB for the second transmission occasion.

In a further particular embodiment, the update DCI 135 may include information of the division of resources for one or more transmission occasions. For example, the update DCI 135 may indicate a division of resources that is applicable to x upcoming transmission occasions. Alternatively, the update DCI 135 can indicate one resource division for the transmission occasion x (e.g., URLLC is allocated with 20% resources and eMBB is allocated 80% of resource) and a different resource allocation for the transmission occasion x+1 (e.g., URLLC is allocated with 30% resources and eMBB is allocated 70% of resources).

In a particular embodiment, the update DCI 135 may be enhanced to include a timer or a number of following transmission occasions for which the contents of the update DCI 135 will apply. Any one or more of the following options may apply:
a. Whenever an update DCI 135 is sent, the change may apply for all the following transmission occasions after the update DCI 135 unless a new update DCI comes later. This is depicted in FIG. 3 where the same resource division is applied in two transmission occasions after the update DCI 135 is received.
b. In another option, the change in the division of resources may apply to only X number of occasions following the update DCI 135, and after X occasions, the division of resources in the occasion may switch back to a previous division of resources or to a default division of resources, where X≥1. For example, in a particular embodiment, the new division corresponding to 50% resource division for both traffic types 120a-b may apply for X=10 transmission occasions. After 10 transmission occasions, i.e., from 12th occasion onwards in FIG. 3, the division of resources may switch back to a default division of resources, which may include the division of resources used for the first transmission occasion, i.e., URLLC is allocated with 20% resources and eMBB is allocated 80% of resource. Regarding default allocation, it can be expressed in activation DCI or activation RRC messaging. Additionally, in a particular embodiment, the parameter X may be set in activation DCI 130 or in an RRC activation message.
c. In a particular embodiment, the parameter X (in option b) can be expressed in time (ms or s, etc.) or slots, or symbols instead of number of transmission occasions. Therefore, the resource division change indicated in update DCI 135 may apply for all the transmission occasions that fall in time X followed the update DCI 135.

In a particular embodiment, for a grant (occasion) in a CG period over which multiple traffic types are transmitted, the transmission can be configured with multiple options. For example, based on FIG. 3, the transmission options may include any one or more of:
a. In a particular embodiment, URLLC data and eMBB data may be encoded as two separate sub-TBs and both may be packed into 1 TB. These two sub-TBs may correspond to each traffic type. For example, in the first transmission occasion depicted in FIG. 3, the URLLC sub-TB maps to 20% of occasion and eMBB sub-TB maps to 80% of occasion. This means both sub-TBs can be encoded with same or different MCS. Further, as both sub-TBs are packed into single TB, then the RNTI (e.g., C-RNTI) may be scrambled with TB (instead of sub-TBs),
b. In a particular embodiment, one TB may be generated containing combined URLLC data and eMBB data, where the TB is encoded with a given MCS scheme. The data (bits) in TB would be fill in such a manner that, for example, corresponding to the first transmission occasion in FIG. 3, in a TB, the URLLC data accounts for 20% usage and the eMBB data accounts for 80% usage; it means, if a TB contains 1000 information bits, out of which 200 information bits belong to URLLC traffic and rest 800 information bits belong to eMBB traffic.
c. In a particular embodiment, the traffic data packed in a single TB where within the TB may be encoded the same or differently. There could be two sub-TBs corresponding to each traffic where URLLC sub-TB maps to 20% of occasion and eMBB sub-TB maps to 80% of occasion; this means both sub-TBs can be encoded with same or different MCS; further as both sub-TBs are packed into single TB, then the RNTI (e.g., C-RNTI) is scrambled with TB (instead of sub-TBs),
d. In a particular embodiment, two distinct TBs are transmitted: one for URLLC and one for eMBB. Specifically, URLLC TB may be transmitted in the first transmission occasion over the indicated 20% of the transmission occasion (2 symbols) and the eMBB TB transmitted over 80% of the transmission occasion (8 symbols).

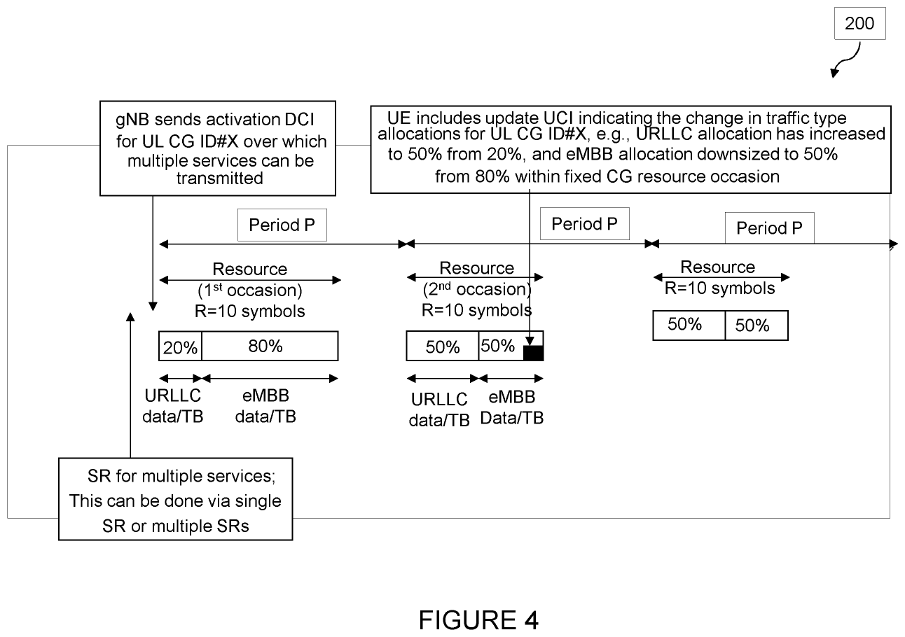

In a particular embodiment (applicable to UL data transmission), instead of SR and update DCI, UE may include UCI that indicates the proportion of resource utilization of the grant for a given traffic type. For example, in FIG. 3, in the second transmission occasion, UCI can be included to indicate 50% resource or data is used for URLLC traffic and other 50% resource or data is used for eMBB traffic. FIG. 4 illustrates this new allocation process. Specifically, FIG. 4 illustrates a UE including update UCI to indicate splitting of CG occasion for URLLC and eMBB usage, according to a particular embodiment.

In various particular embodiments, TB(s) can be formed or packed in a multi-service allocation in various ways. For example, UCI can be multiplexed using any of the following approaches:
a. UCI can be multiplexed with TB (7-a, 7-b, 7-c)
b. UCI is multiplexed with sub-TBs (7-a, 7-b)
c. In 7-d, option, UCI is multiplexed with either or both TBs
d. UCI is sent over separate PUCCH or PUSCH resource.

Further, in another particular embodiment, the UCI may convey knowledge as to how the resource division will carry out in the incoming occasions. For example,
a. In a particular embodiment, the UCI may be sent in every transmission occasion to indicate the division of resources.
b. In another particular embodiment, whenever there is changes in the division of resources among the traffic allocation over the transmission occasion, the UCI may be sent. If there are no changes among the traffic allocation over the transmission occasion relative to a previous transmission occasion, the UCI may not be sent. The gNB may then assume the resource division over this transmission occasion is similar to previous occasion
c. In another particular embodiment, the UCI may indicate a number of transmission occasions or a time window for which the traffic allocation division over the transmission occasion is applicable.
d. Alternatively, in a particular embodiment, instead of update DCI, the UCI may convey the information on how the new resource division over the transmission occasion(s) will apply.
e. In another particular embodiment, the initial activation DCI and/or the update DCI provided by the gNB could indicate whether the UE is allowed to change the traffic allocation of CG resource allocation, e.g., by using UCI.

In a particular embodiment, in order to request change in division of resource among the traffic types, the UE may send a SR or multiple SRs, where
a. single SR can be mapped to request for granting a single service (URLLC or eMBB), i.e., to indicate URLLC and eMBB traffic, URLLC SR and eMBB SR is required, or
b. single SR can be mapped to request for grant for multiple services or traffic types (e.g., URLLC and eMBB).

Further in SR, a UE can mention the CG ID, the parameter X (for how many occasion or time window) for which UE desires the change in resource usage among the traffic types. Further, a UÉ can indicate in SR, the desired division of resources in the occasion for different traffic types, etc. Further, the UE may report change in traffic volume among different traffic types via, for example:
a. BSR on previous CG occasion (e.g., in the transmission occasion belong to CG ID # in FIG. 3)
b. BSR on separate unrelated grant (some other dynamic grant PUSCH or CG PUSCH)
c. SR (single or multiple SRs).

Similarly, for DL transmission scenarios, DL SPS may be used instead of UL CG. In a particular embodiment, the gNB may send update DCI containing new division of resources among different traffic types in the SPS occasions using any of the embodiments described above.

In a particular embodiment, instead of update DCI, the gNB may multiplex DCI in the TB(s) using an option similar to the options described above, where instead of UCI, DCI is included to indicate the division of resources for the occasion.

In a particular embodiment, the gNB may have information about the patterns of the traffic associated to the CG/SPS. Such information can be obtained, for example, directly from the UE via BSRs/SRs or other signaling from the UE, or directly by a gNB by means of some estimation/ML/AI algorithms, or generated by another network entity (e.g., a core network function) and provided to the gNB. In certain embodiments, the gNB may use such information to generate the update DCI and provide it to the UE, without the need for the gNB to receive an SR from the UE.

In a further particular embodiment, where UCI can be sent to indicate autonomous splitting, the gNB may further lay rules or add restriction which splitting is allowed or not. For example, the gNB may configure the UE with RRC information or with activation CG DCI that indicates, regarding the splitting, that the UE is allowed to use or choose from certain number of splitting types. For example, in a particular example scenario, the UE may be allowed to use or choose from three splitting types: (a) 10% for URLLC and 90% for eMBB, (b) 20% for URLLC and 80% for eMBB, and (c) 30% for URLLC and 70% for eMBB. Hence, when the UE does autonomous splitting of occasion for multiple traffic, the UE may choose the options which are in RRC table, either (a) or (b) or (c).

In a particular embodiment, if the UE is allowed to autonomously split (via UCI), then the gNB can restrict TB length for certain traffics. For example, the gNB may configure UE with following example information:
a. The minimum URLLC TB size is 2 OS
   i. If a UE has data equivalent to less than 2 OS, then either UE adds padding/dummy bits to make it 2 OS or wait for more data in buffer so that UE can construct 2 OS sized TB
b. The minimum URLLC TB size is 5 OS
c. Similarly, the maximum size can be set for different traffic types' TBs.

In a particular embodiment, the gNB may set the priorities of traffic and accordingly should be given preference. For example, in addition to indicating the split, the gNB may also indicate the portion to be used based on priority. For example, in FIG. 3, in the first transmission occasion, the 20% resource is meant high priority traffic, i.e., URLLC, and the remaining 80% of the resource is for low priority traffic, i.e., eMBB traffic. However, in the case of the FIG. 4 based approach (split indicated via UCI), then the gNB may configure the UE with RRC information about priorities, e.g., when UE decided to split occasion, UE utilize the occasion for high priority and the remaining resource for low priority traffic. For example, if we have a full buffer eMBB traffic, and URLLC data equivalent to 2 OS, then in 10 OS occasion, UE utilizes 2 OS out of 10 OS for URLLC TB and rest 8 OS for eMBB TB. Further, the gNB can add conditions in RRC, e.g., the high priority traffic begins with at specific location in the occasion such as, for example, the beginning of the occasion or 1st OS in occasion.

In a particular embodiment, if UCI is sent in an occasion, it can indicate any one or more of the following information:
a. Splitting information: Occasion is split for different traffic types, e.g., 20% for TSN, 20% for URLLC and 60% for eMBB traffic
b. New/update TB encoding parameters, e.g., MCS, RV, K repetitions, precoding information, etc. For example, if by default URLLC TB's MCS set as MCS 1 with single repetition and eMBB MCS set as MCS 6 with single repetition, then UE can select new encoding parameters and convey these parameters via UCI, e.g., UE can indicate URLLC TB is encoded with MCS 3 and K=2 repetitions (instead of default or previous parameters, i.e., MCS 1 and K=1 repetition), and same for eMBB TB, if UE encodes eMBB TB with new encoding parameters, then update parameters are reported in the same or different UCI, one for URLLC and one for eMBB. Similar to embodiment 12, gNB can restrict parameters MCS, RVs, precoders selection (which UE can autonomously select), e.g., UE can select MCS from specific subset of MCS
c. Combination of above, e.g., in UCI, UE can indicate splitting ratio, as well as updated encoding parameters.

In a particular embodiment, the gNB may employ smart/blind decoding. Above, two techniques with splitting are provided: (a) gNB decided the splitting and sends the information via DCI, (b) UE autonomously selects the splitting proportion and indicates via UCI. However, in a third option, the UE may autonomously do the splitting of transmission occasion for different traffic TBs' transmission without UCI. Instead, the gNB may employ blind decoding and try to find the TBs on the occasion. To simply the task for the gNB, the gNB can define some rules to be used by the UE. Some of the following rules may be applied and are provided for example purposes only:
a. TB should at certain OFDM symbol (OS), e.g., 1st OS, 5th OS in an occasion, etc.,
b. Beginning of TB contains DMRS, then whenever one or more TBs are sent over occasion, gNB checks DMRSs, then gNB knows each TB begins at DMRS location and ends before DMRS of next TB or ends at end of the occasion,
   ii. Further gNB can limit in which symbols, DMRS is allowed, it means the possibilities of transmission will reduce as starting locations are restricted,
   iii. In another, gNB can put a rule that DMRS can be 2^{nd} OS in a TB (not at 1^{st} OS in a TB), i.e., DMRS location within a TB can set,
      c. TB should be of certain lengths, e.g., OS 2, OS 4, OS 6 etc.,
      d. Splitting should be of certain proportion, e.g., similar to embodiment 12.
      e. In one option, instead DMRS, a new reference signal can be included in TB which indicates the TB presence (or adopt some properties of DMRS we described above)

Take an example where an occasion size is of 10 OS in a slot of 14 OS, and the occasion is located over first 10 OS in the slot. The UE may be allowed to start TB at symbol 1, 3 and 5, and the TB sizes are allowed 2 OS, 4 OS, 6 OS, 8 OS or 10 OS. Now, the UE has URLLC and eMBB traffic and decides to transmit URLLC TB beginning at 1^{st} OS with size OS 4 and eMBB TB begins at 5^{th} OS with size OS 6. When the gNB receives the TB(s), the gNB will check TB beginning at 1^{st} OS with size 10, but decoding will fails, then it will check for two TBs beginning at 1^{st} OS and 3^{rd} OS with respective sizes of OS 2 and 6, but decoding with fail, then it checks for two TBs beginning at 1^{st} and 5^{th} OS with respective sizes OS 4 and 6, then gNB gets a decoding success.

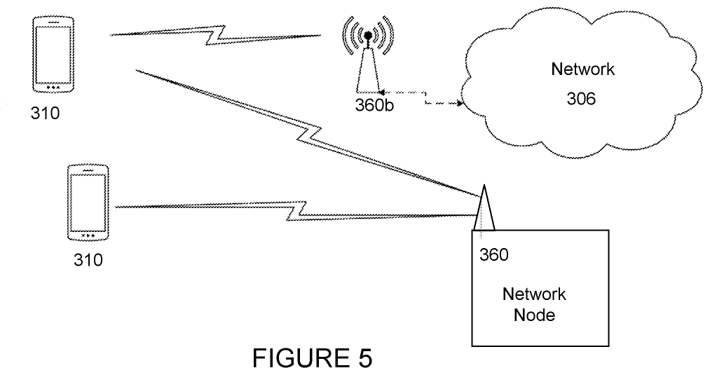

FIG. 5 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 306, network nodes 360 and 360b, and wireless devices 310, 310b, and 310c. In practice, a wireless network may further include any additional elements suitable to support communication between wireless devices or between a wireless device and another communication device, such as a landline telephone, a service provider, or any other network node or end device. Of the illustrated components, network node 360 and wireless device 310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 360 and wireless device 310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

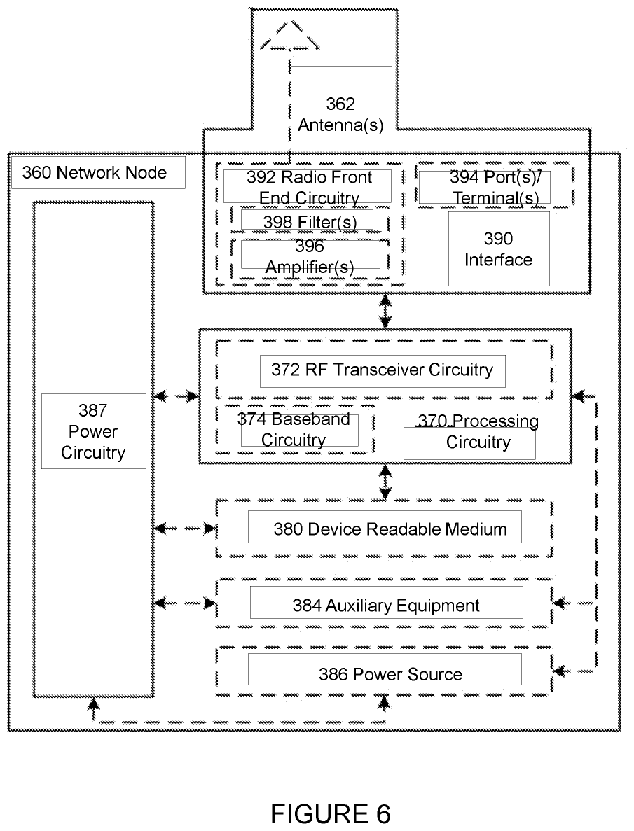

FIG. 6 illustrates an example network node 360, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 360 includes processing circuitry 370, device readable medium 380, interface 390, auxiliary equipment 384, power source 386, power circuitry 387, and antenna 362. Although network node 360 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 360 are depicted as single boxes located within a larger box, or nested within multiple boxes, in practice, a network node may comprise multiple different physical components that make up a single illustrated component (e.g., device readable medium 380 may comprise multiple separate hard drives as well as multiple RAM modules).

Similarly, network node 360 may be composed of multiple physically separate components (e.g., a NodeB component and a RNC component, or a BTS component and a BSC component, etc.), which may each have their own respective components. In certain scenarios in which network node 360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 360 may be configured to support multiple radio access technologies (RATs). In such embodiments, some components may be duplicated (e.g., separate device readable medium 380 for the different RATs) and some components may be reused (e.g., the same antenna 362 may be shared by the RATs). Network node 360 may also include multiple sets of the various illustrated components for different wireless technologies integrated into network node 360, such as, for example, GSM, WCDMA, LTE, NR, WiFi, or Bluetooth wireless technologies. These wireless technologies may be integrated into the same or different chip or set of chips and other components within network node 360.

Processing circuitry 370 is configured to perform any determining, calculating, or similar operations (e.g., certain obtaining operations) described herein as being provided by a network node. These operations performed by processing circuitry 370 may include processing information obtained by processing circuitry 370 by, for example, converting the obtained information into other information, comparing the obtained information or converted information to information stored in the network node, and/or performing one or more operations based on the obtained information or converted information, and as a result of said processing making a determination.

Processing circuitry 370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 360 components, such as device readable medium 380, network node 360 functionality. For example, processing circuitry 370 may execute instructions stored in device readable medium 380 or in memory within processing circuitry 370. Such functionality may include providing any of the various wireless features, functions, or benefits discussed herein. In some embodiments, processing circuitry 370 may include a system on a chip (SOC).

In some embodiments, processing circuitry 370 may include one or more of radio frequency (RF) transceiver circuitry 372 and baseband processing circuitry 374. In some embodiments, radio frequency (RF) transceiver circuitry 372 and baseband processing circuitry 374 may be on separate chips (or sets of chips), boards, or units, such as radio units and digital units. In alternative embodiments, part or all of RF transceiver circuitry 372 and baseband processing circuitry 374 may be on the same chip or set of chips, boards, or units.

In certain embodiments, some or all of the functionality described herein as being provided by a network node, base station, eNB or other such network device may be performed by processing circuitry 370 executing instructions stored on device readable medium 380 or memory within processing circuitry 370. In alternative embodiments, some or all of the functionality may be provided by processing circuitry 370 without executing instructions stored on a separate or discrete device readable medium, such as in a hard-wired manner. In any of those embodiments, whether executing instructions stored on a device readable storage medium or not, processing circuitry 370 can be configured to perform the described functionality. The benefits provided by such functionality are not limited to processing circuitry 370 alone or to other components of network node 360 but are enjoyed by network node 360 as a whole, and/or by end users and the wireless network generally.

Device readable medium 380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 370. Device readable medium 380 may store any suitable instructions, data or information, including a computer program, software, an application including one or more of logic, rules, code, tables, etc. and/or other instructions capable of being executed by processing circuitry 370 and, utilized by network node 360. Device readable medium 380 may be used to store any calculations made by processing circuitry 370 and/or any data received via interface 390. In some embodiments, processing circuitry 370 and device readable medium 380 may be considered to be integrated.

Interface 390 is used in the wired or wireless communication of signalling and/or data between network node 360, network 306, and/or wireless devices 310. As illustrated, interface 390 comprises port(s)/terminal(s) 394 to send and receive data, for example to and from network 306 over a wired connection. Interface 390 also includes radio front end circuitry 392 that may be coupled to, or in certain embodiments a part of, antenna 362. Radio front end circuitry 392 comprises filters 398 and amplifiers 396. Radio front end circuitry 392 may be connected to antenna 362 and processing circuitry 370. Radio front end circuitry may be configured to condition signals communicated between antenna 362 and processing circuitry 370. Radio front end circuitry 392 may receive digital data that is to be sent out to other network nodes or wireless devices via a wireless connection. Radio front end circuitry 392 may convert the digital data into a radio signal having the appropriate channel and bandwidth parameters using a combination of filters 398 and/or amplifiers 396. The radio signal may then be transmitted via antenna 362. Similarly, when receiving data, antenna 362 may collect radio signals which are then converted into digital data by radio front end circuitry 392. The digital data may be passed to processing circuitry 370. In other embodiments, the interface may comprise different components and/or different combinations of components.

In certain alternative embodiments, network node 360 may not include separate radio front end circuitry 392, instead, processing circuitry 370 may comprise radio front end circuitry and may be connected to antenna 362 without separate radio front end circuitry 392. Similarly, in some embodiments, all or some of RF transceiver circuitry 372 may be considered a part of interface 390. In still other embodiments, interface 390 may include one or more ports or terminals 394, radio front end circuitry 392, and RF transceiver circuitry 372, as part of a radio unit (not shown), and interface 390 may communicate with baseband processing circuitry 374, which is part of a digital unit (not shown).

Antenna 362 may include one or more antennas, or antenna arrays, configured to send and/or receive wireless signals. Antenna 362 may be coupled to radio front end circuitry 392 and may be any type of antenna capable of transmitting and receiving data and/or signals wirelessly. In some embodiments, antenna 362 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 362 may be separate from network node 360 and may be connectable to network node 360 through an interface or port.

Antenna 362, interface 390, and/or processing circuitry 370 may be configured to perform any receiving operations and/or certain obtaining operations described herein as being performed by a network node. Any information, data and/or signals may be received from a wireless device, another network node and/or any other network equipment. Similarly, antenna 362, interface 390, and/or processing circuitry 370 may be configured to perform any transmitting operations described herein as being performed by a network node. Any information, data and/or signals may be transmitted to a wireless device, another network node and/or any other network equipment.

Power circuitry 387 may comprise, or be coupled to, power management circuitry and is configured to supply the components of network node 360 with power for performing the functionality described herein. Power circuitry 387 may receive power from power source 386. Power source 386 and/or power circuitry 387 may be configured to provide power to the various components of network node 360 in a form suitable for the respective components (e.g., at a voltage and current level needed for each respective component). Power source 386 may either be included in, or external to, power circuitry 387 and/or network node 360. For example, network node 360 may be connectable to an external power source (e.g., an electricity outlet) via an input circuitry or interface such as an electrical cable, whereby the external power source supplies power to power circuitry 387. As a further example, power source 386 may comprise a source of power in the form of a battery or battery pack which is connected to, or integrated in, power circuitry 387. The battery may provide backup power should the external power source fail. Other types of power sources, such as photovoltaic devices, may also be used.

Alternative embodiments of network node 360 may include additional components beyond those shown in FIG. 6 that may be responsible for providing certain aspects of the network node's functionality, including any of the functionality described herein and/or any functionality necessary to support the subject matter described herein. For example, network node 360 may include user interface equipment to allow input of information into network node 360 and to allow output of information from network node 360. This may allow a user to perform diagnostic, maintenance, repair, and other administrative functions for network node 360.

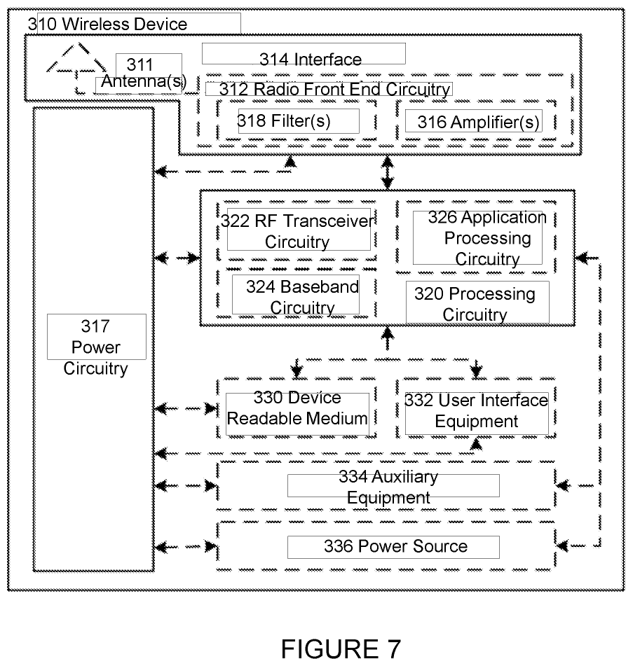

FIG. 7 illustrates an example wireless device 310. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 310 includes antenna 311, interface 314, processing circuitry 320, device readable medium 330, user interface equipment 332, auxiliary equipment 334, power source 336 and power circuitry 337. Wireless device 310 may include multiple sets of one or more of the illustrated components for different wireless technologies supported by wireless device 310, such as, for example, GSM, WCDMA, LTE, NR, WiFi, WiMAX, or Bluetooth wireless technologies, just to mention a few. These wireless technologies may be integrated into the same or different chips or set of chips as other components within wireless device 310.

Antenna 311 may include one or more antennas or antenna arrays, configured to send and/or receive wireless signals, and is connected to interface 314. In certain alternative embodiments, antenna 311 may be separate from wireless device 310 and be connectable to wireless device 310 through an interface or port. Antenna 311, interface 314, and/or processing circuitry 320 may be configured to perform any receiving or transmitting operations described herein as being performed by a wireless device. Any information, data and/or signals may be received from a network node and/or another wireless device. In some embodiments, radio front end circuitry and/or antenna 311 may be considered an interface.

As illustrated, interface 314 comprises radio front end circuitry 312 and antenna 311. Radio front end circuitry 312 comprise one or more filters 318 and amplifiers 316. Radio front end circuitry 312 is connected to antenna 311 and processing circuitry 320 and is configured to condition signals communicated between antenna 311 and processing circuitry 320. Radio front end circuitry 312 may be coupled to or a part of antenna 311. In some embodiments, wireless device 310 may not include separate radio front end circuitry 312; rather, processing circuitry 320 may comprise radio front end circuitry and may be connected to antenna 311. Similarly, in some embodiments, some or all of RF transceiver circuitry 322 may be considered a part of interface 314. Radio front end circuitry 312 may receive digital data that is to be sent out to other network nodes or wireless devices via a wireless connection. Radio front end circuitry 312 may convert the digital data into a radio signal having the appropriate channel and bandwidth parameters using a combination of filters 318 and/or amplifiers 316. The radio signal may then be transmitted via antenna 311. Similarly, when receiving data, antenna 311 may collect radio signals which are then converted into digital data by radio front end circuitry 312. The digital data may be passed to processing circuitry 320. In other embodiments, the interface may comprise different components and/or different combinations of components.

Processing circuitry 320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 310 components, such as device readable medium 330, wireless device 310 functionality. Such functionality may include providing any of the various wireless features or benefits discussed herein. For example, processing circuitry 320 may execute instructions stored in device readable medium 330 or in memory within processing circuitry 320 to provide the functionality disclosed herein.

As illustrated, processing circuitry 320 includes one or more of RF transceiver circuitry 322, baseband processing circuitry 324, and application processing circuitry 326. In other embodiments, the processing circuitry may comprise different components and/or different combinations of components. In certain embodiments processing circuitry 320 of wireless device 310 may comprise a SOC. In some embodiments, RF transceiver circuitry 322, baseband processing circuitry 324, and application processing circuitry 326 may be on separate chips or sets of chips. In alternative embodiments, part or all of baseband processing circuitry 324 and application processing circuitry 326 may be combined into one chip or set of chips, and RF transceiver circuitry 322 may be on a separate chip or set of chips. In still alternative embodiments, part or all of RF transceiver circuitry 322 and baseband processing circuitry 324 may be on the same chip or set of chips, and application processing circuitry 326 may be on a separate chip or set of chips. In yet other alternative embodiments, part or all of RF transceiver circuitry 322, baseband processing circuitry 324, and application processing circuitry 326 may be combined in the same chip or set of chips. In some embodiments, RF transceiver circuitry 322 may be a part of interface 314. RF transceiver circuitry 322 may condition RF signals for processing circuitry 320.

In certain embodiments, some or all of the functionality described herein as being performed by a wireless device may be provided by processing circuitry 320 executing instructions stored on device readable medium 330, which in certain embodiments may be a computer-readable storage medium. In alternative embodiments, some or all of the functionality may be provided by processing circuitry 320 without executing instructions stored on a separate or discrete device readable storage medium, such as in a hard-wired manner. In any of those particular embodiments, whether executing instructions stored on a device readable storage medium or not, processing circuitry 320 can be configured to perform the described functionality. The benefits provided by such functionality are not limited to processing circuitry 320 alone or to other components of wireless device 310, but are enjoyed by wireless device 310 as a whole, and/or by end users and the wireless network generally.

Processing circuitry 320 may be configured to perform any determining, calculating, or similar operations (e.g., certain obtaining operations) described herein as being performed by a wireless device. These operations, as performed by processing circuitry 320, may include processing information obtained by processing circuitry 320 by, for example, converting the obtained information into other information, comparing the obtained information or converted information to information stored by wireless device 310, and/or performing one or more operations based on the obtained information or converted information, and as a result of said processing making a determination.

Device readable medium 330 may be operable to store a computer program, software, an application including one or more of logic, rules, code, tables, etc. and/or other instructions capable of being executed by processing circuitry 320. Device readable medium 330 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 320. In some embodiments, processing circuitry 320 and device readable medium 330 may be considered to be integrated.

User interface equipment 332 may provide components that allow for a human user to interact with wireless device 310. Such interaction may be of many forms, such as visual, audial, tactile, etc. User interface equipment 332 may be operable to produce output to the user and to allow the user to provide input to wireless device 310. The type of interaction may vary depending on the type of user interface equipment 332 installed in wireless device 310. For example, if wireless device 310 is a smart phone, the interaction may be via a touch screen; if wireless device 310 is a smart meter, the interaction may be through a screen that provides usage (e.g., the number of gallons used) or a speaker that provides an audible alert (e.g., if smoke is detected). User interface equipment 332 may include input interfaces, devices and circuits, and output interfaces, devices and circuits. User interface equipment 332 is configured to allow input of information into wireless device 310 and is connected to processing circuitry 320 to allow processing circuitry 320 to process the input information. User interface equipment 332 may include, for example, a microphone, a proximity or other sensor, keys/buttons, a touch display, one or more cameras, a USB port, or other input circuitry. User interface equipment 332 is also configured to allow output of information from wireless device 310, and to allow processing circuitry 320 to output information from wireless device 310. User interface equipment 332 may include, for example, a speaker, a display, vibrating circuitry, a USB port, a headphone interface, or other output circuitry. Using one or more input and output interfaces, devices, and circuits, of user interface equipment 332, wireless device 310 may communicate with end users and/or the wireless network and allow them to benefit from the functionality described herein.

Auxiliary equipment 334 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 334 may vary depending on the embodiment and/or scenario.

Power source 336 may, in some embodiments, be in the form of a battery or battery pack. Other types of power sources, such as an external power source (e.g., an electricity outlet), photovoltaic devices or power cells, may also be used. wireless device 310 may further comprise power circuitry 337 for delivering power from power source 336 to the various parts of wireless device 310 which need power from power source 336 to carry out any functionality described or indicated herein. Power circuitry 337 may in certain embodiments comprise power management circuitry. Power circuitry 337 may additionally or alternatively be operable to receive power from an external power source; in which case wireless device 310 may be connectable to the external power source (such as an electricity outlet) via input circuitry or an interface such as an electrical power cable. Power circuitry 337 may also in certain embodiments be operable to deliver power from an external power source to power source 336. This may be, for example, for the charging of power source 336. Power circuitry 337 may perform any formatting, converting, or other modification to the power from power source 336 to make the power suitable for the respective components of wireless device 310 to which power is supplied.

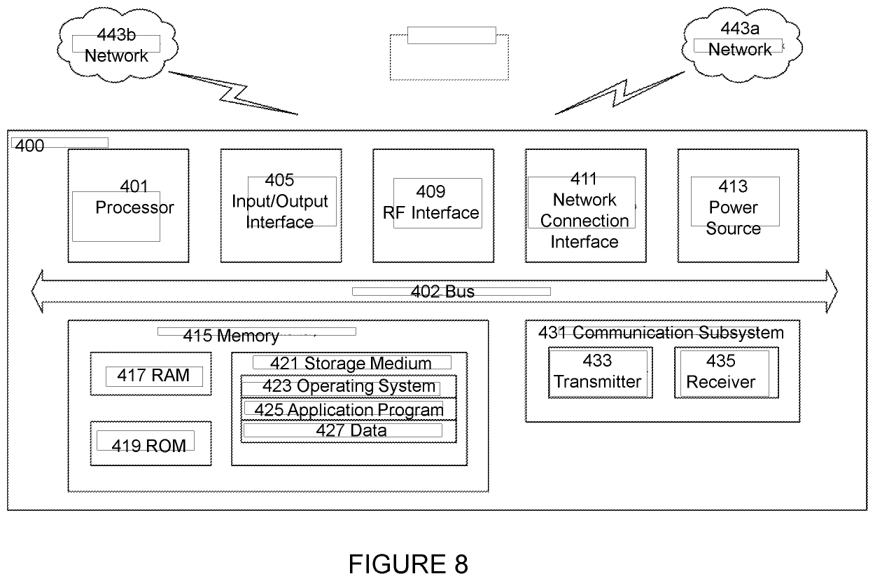

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 400 may be any UE identified by the 3^{rd} Generation Partnership Project (3GPP), including a NB-IOT UE, a machine type communication (MTC) UE, and/or an enhanced MTC (eMTC) UE. UE 400, as illustrated in FIG. 6, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 8 is a UE, the components discussed herein are equally applicable to a wireless device, and vice-versa.

In FIG. 8, UE 400 includes processing circuitry 401 that is operatively coupled to input/output interface 405, radio frequency (RF) interface 409, network connection interface 411, memory 415 including random access memory (RAM) 417, read-only memory (ROM) 419, and storage medium 421 or the like, communication subsystem 431, power source 433, and/or any other component, or any combination thereof. Storage medium 421 includes operating system 423, application program 425, and data 427. In other embodiments, storage medium 421 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 401 may be configured to process computer instructions and data. Processing circuitry 401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 401 may include two central processing units (CPUs). Data may be information in a form suitable for use by a computer.

In the depicted embodiment, input/output interface 405 may be configured to provide a communication interface to an input device, output device, or input and output device. UE 400 may be configured to use an output device via input/output interface 405. An output device may use the same type of interface port as an input device. For example, a USB port may be used to provide input to and output from UE 400. The output device may be a speaker, a sound card, a video card, a display, a monitor, a printer, an actuator, an emitter, a smartcard, another output device, or any combination thereof. UE 400 may be configured to use an input device via input/output interface 405 to allow a user to capture information into UE 400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 409 may be configured to provide a communication interface to RF components such as a transmitter, a receiver, and an antenna. Network connection interface 411 may be configured to provide a communication interface to network 443a. Network 443a may encompass wired and/or wireless networks such as a local-area network (LAN), a wide-area network (WAN), a computer network, a wireless network, a telecommunications network, another like network or any combination thereof. For example, network 443a may comprise a Wi-Fi network. Network connection interface 411 may be configured to include a receiver and a transmitter interface used to communicate with one or more other devices over a communication network according to one or more communication protocols, such as Ethernet, TCP/IP, SONET, ATM, or the like. Network connection interface 411 may implement receiver and transmitter functionality appropriate to the communication network links (e.g., optical, electrical, and the like). The transmitter and receiver functions may share circuit components, software or firmware, or alternatively may be implemented separately.

RAM 417 may be configured to interface via bus 402 to processing circuitry 401 to provide storage or caching of data or computer instructions during the execution of software programs such as the operating system, application programs, and device drivers. ROM 419 may be configured to provide computer instructions or data to processing circuitry 401. For example, ROM 419 may be configured to store invariant low-level system code or data for basic system functions such as basic input and output (I/O), startup, or reception of keystrokes from a keyboard that are stored in a non-volatile memory. Storage medium 421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 421 may be configured to include operating system 423, application program 425 such as a web browser application, a widget or gadget engine or another application, and data file 427. Storage medium 421 may store, for use by UE 400, any of a variety of various operating systems or combinations of operating systems.

Storage medium 421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 421 may allow UE 400 to access computer-executable instructions, application programs or the like, stored on transitory or non-transitory memory media, to off-load data, or to upload data. An article of manufacture, such as one utilizing a communication system may be tangibly embodied in storage medium 421, which may comprise a device readable medium.

In FIG. 8, processing circuitry 401 may be configured to communicate with network 443b using communication subsystem 431. Network 443a and network 443b may be the same network or networks or different network or networks. Communication subsystem 431 may be configured to include one or more transceivers used to communicate with network 443b. For example, communication subsystem 431 may be configured to include one or more transceivers used to communicate with one or more remote transceivers of another device capable of wireless communication such as another wireless device, UE, or base station of a radio access network (RAN) according to one or more communication protocols, such as IEEE 802.4, CDMA, WCDMA, GSM, LTE, UTRAN, WiMax, or the like. Each transceiver may include transmitter 433 and/or receiver 435 to implement transmitter or receiver functionality, respectively, appropriate to the RAN links (e.g., frequency allocations and the like). Further, transmitter 433 and receiver 435 of each transceiver may share circuit components, software or firmware, or alternatively may be implemented separately.

In the illustrated embodiment, the communication functions of communication subsystem 431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 431 may include cellular communication, Wi-Fi communication, Bluetooth communication, and GPS communication. Network 443b may encompass wired and/or wireless networks such as a local-area network (LAN), a wide-area network (WAN), a computer network, a wireless network, a telecommunications network, another like network or any combination thereof. For example, network 443b may be a cellular network, a Wi-Fi network, and/or a near-field network. Power source 413 may be configured to provide alternating current (AC) or direct current (DC) power to components of UE 400.

The features, benefits and/or functions described herein may be implemented in one of the components of UE 400 or partitioned across multiple components of UE 400. Further, the features, benefits, and/or functions described herein may be implemented in any combination of hardware, software or firmware. In one example, communication subsystem 431 may be configured to include any of the components described herein. Further, processing circuitry 401 may be configured to communicate with any of such components over bus 402. In another example, any of such components may be represented by program instructions stored in memory that when executed by processing circuitry 401 perform the corresponding functions described herein. In another example, the functionality of any of such components may be partitioned between processing circuitry 401 and communication subsystem 431. In another example, the non-computationally intensive functions of any of such components may be implemented in software or firmware and the computationally intensive functions may be implemented in hardware.

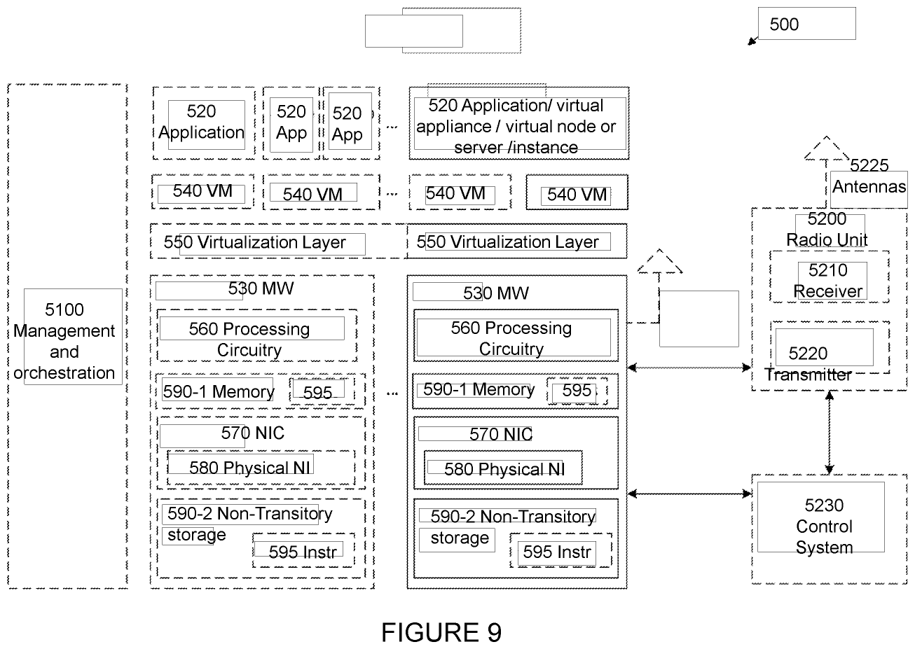

FIG. 9 is a schematic block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 500 hosted by one or more of hardware nodes 530. Further, in embodiments in which the virtual node is not a radio access node or does not require radio connectivity (e.g., a core network node), then the network node may be entirely virtualized.

The functions may be implemented by one or more applications 520 (which may alternatively be called software instances, virtual appliances, network functions, virtual nodes, virtual network functions, etc.) operative to implement some of the features, functions, and/or benefits of some of the embodiments disclosed herein. Applications 520 are run in virtualization environment 500 which provides hardware 530 comprising processing circuitry 560 and memory 590. Memory 590 contains instructions 595 executable by processing circuitry 560 whereby application 520 is operative to provide one or more of the features, benefits, and/or functions disclosed herein.

Virtualization environment 500, comprises general-purpose or special-purpose network hardware devices 530 comprising a set of one or more processors or processing circuitry 560, which may be commercial off-the-shelf (COTS) processors, dedicated Application Specific Integrated Circuits (ASICs), or any other type of processing circuitry including digital or analog hardware components or special purpose processors. Each hardware device may comprise memory 590-1 which may be non-persistent memory for temporarily storing instructions 595 or software executed by processing circuitry 560. Each hardware device may comprise one or more network interface controllers (NICs) 570, also known as network interface cards, which include physical network interface 580. Each hardware device may also include non-transitory, persistent, machine-readable storage media 590-2 having stored therein software 595 and/or instructions executable by processing circuitry 560. Software 595 may include any type of software including software for instantiating one or more virtualization layers 550 (also referred to as hypervisors), software to execute virtual machines 540 as well as software allowing it to execute functions, features and/or benefits described in relation with some embodiments described herein.

Virtual machines 540, comprise virtual processing, virtual memory, virtual networking or interface and virtual storage, and may be run by a corresponding virtualization layer 550 or hypervisor. Different embodiments of the instance of virtual appliance 520 may be implemented on one or more of virtual machines 540, and the implementations may be made in different ways.

During operation, processing circuitry 560 executes software 595 to instantiate the hypervisor or virtualization layer 550, which may sometimes be referred to as a virtual machine monitor (VMM). Virtualization layer 550 may present a virtual operating platform that appears like networking hardware to virtual machine 540.

As shown in FIG. 9, hardware 530 may be a standalone network node with generic or specific components. Hardware 530 may comprise antenna 5225 and may implement some functions via virtualization. Alternatively, hardware 530 may be part of a larger cluster of hardware (e.g. such as in a data center or customer premise equipment (CPE)) where many hardware nodes work together and are managed via management and orchestration (MANO) 5100, which, among others, oversees lifecycle management of applications 520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 540 may be a software implementation of a physical machine that runs programs as if they were executing on a physical, non-virtualized machine. Each of virtual machines 540, and that part of hardware 530 that executes that virtual machine, be it hardware dedicated to that virtual machine and/or hardware shared by that virtual machine with others of the virtual machines 540, forms a separate virtual network elements (VNE).

Still in the context of NFV, Virtual Network Function (VNF) is responsible for handling specific network functions that run in one or more virtual machines 540 on top of hardware networking infrastructure 530 and corresponds to application 520 in FIG. 9.

In some embodiments, one or more radio units 5200 that each include one or more transmitters 5220 and one or more receivers 5210 may be coupled to one or more antennas 5225. Radio units 5200 may communicate directly with hardware nodes 530 via one or more appropriate network interfaces and may be used in combination with the virtual components to provide a virtual node with radio capabilities, such as a radio access node or a base station.

In some embodiments, some signaling can be affected with the use of control system 5230 which may alternatively be used for communication between the hardware nodes 530 and radio units 5200.

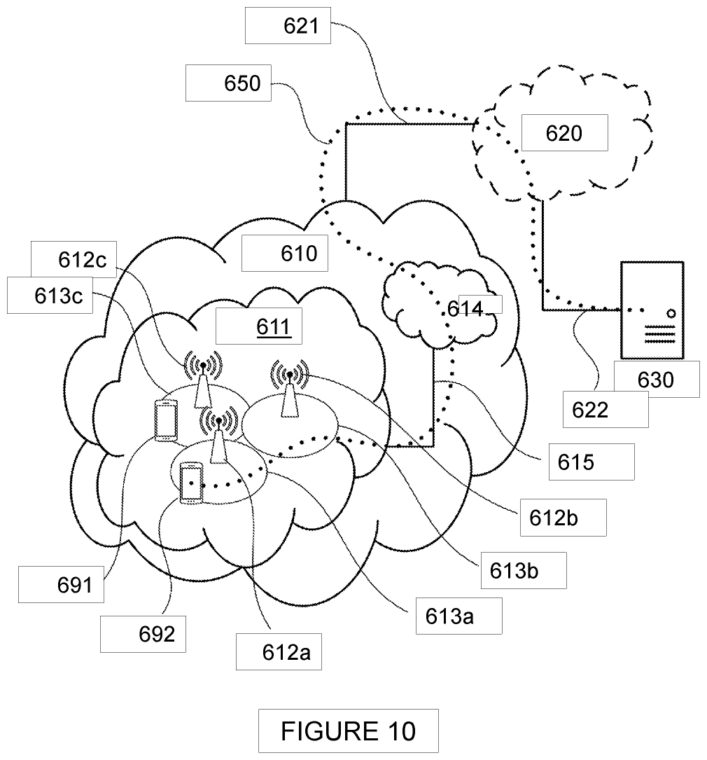

FIG. 10 illustrates a telecommunication network connected via an intermediate network to a host computer in accordance with some embodiments.

With reference to FIG. 10, in accordance with an embodiment, a communication system includes telecommunication network 610, such as a 3GPP-type cellular network, which comprises access network 611, such as a radio access network, and core network 614. Access network 611 comprises a plurality of base stations 612a, 612b, 612c, such as NBs, eNBs, gNBs or other types of wireless access points, each defining a corresponding coverage area 613a, 613b, 613c. Each base station 612a, 612b, 612c is connectable to core network 614 over a wired or wireless connection 615. A first UE 691 located in coverage area 613c is configured to wirelessly connect to, or be paged by, the corresponding base station 612c. A second UE 692 in coverage area 613a is wirelessly connectable to the corresponding base station 612a. While a plurality of UEs 691, 692 are illustrated in this example, the disclosed embodiments are equally applicable to a situation where a sole UE is in the coverage area or where a sole UE is connecting to the corresponding base station 612.

Telecommunication network 610 is itself connected to host computer 630, which may be embodied in the hardware and/or software of a standalone server, a cloud-implemented server, a distributed server or as processing resources in a server farm. Host computer 630 may be under the ownership or control of a service provider or may be operated by the service provider or on behalf of the service provider. Connections 621 and 622 between telecommunication network 610 and host computer 630 may extend directly from core network 614 to host computer 630 or may go via an optional intermediate network 620. Intermediate network 620 may be one of, or a combination of more than one of, a public, private or hosted network; intermediate network 620, if any, may be a backbone network or the Internet; in particular, intermediate network 620 may comprise two or more sub-networks (not shown).

The communication system of FIG. 10 as a whole enables connectivity between the connected UEs 691, 692 and host computer 630. The connectivity may be described as an over-the-top (OTT) connection 650. Host computer 630 and the connected UEs 691, 692 are configured to communicate data and/or signaling via OTT connection 650, using access network 611, core network 614, any intermediate network 620 and possible further infrastructure (not shown) as intermediaries. OTT connection 650 may be transparent in the sense that the participating communication devices through which OTT connection 650 passes are unaware of routing of uplink and downlink communications. For example, base station 612 may not or need not be informed about the past routing of an incoming downlink communication with data originating from host computer 630 to be forwarded (e.g., handed over) to a connected UE 691. Similarly, base station 612 need not be aware of the future routing of an outgoing uplink communication originating from the UE 691 towards the host computer 630.

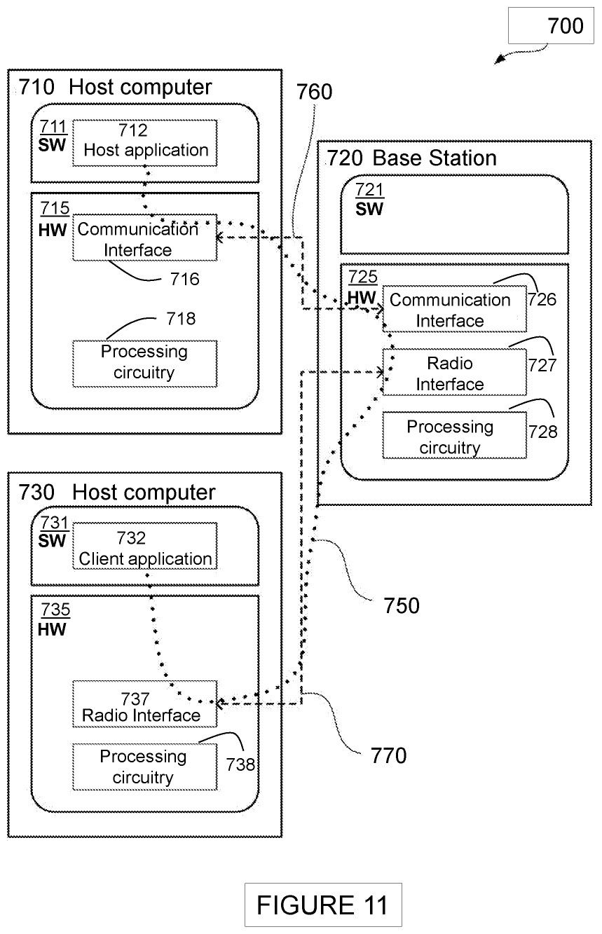

FIG. 11 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 11. In communication system 700, host computer 710 comprises hardware 715 including communication interface 716 configured to set up and maintain a wired or wireless connection with an interface of a different communication device of communication system 700. Host computer 710 further comprises processing circuitry 718, which may have storage and/or processing capabilities. In particular, processing circuitry 718 may comprise one or more programmable processors, application-specific integrated circuits, field programmable gate arrays or combinations of these (not shown) adapted to execute instructions. Host computer 710 further comprises software 711, which is stored in or accessible by host computer 710 and executable by processing circuitry 718. Software 711 includes host application 712. Host application 712 may be operable to provide a service to a remote user, such as UE 730 connecting via OTT connection 750 terminating at UE 730 and host computer 710. In providing the service to the remote user, host application 712 may provide user data which is transmitted using OTT connection 750.

Communication system 700 further includes base station 720 provided in a telecommunication system and comprising hardware 725 enabling it to communicate with host computer 710 and with UE 730. Hardware 725 may include communication interface 726 for setting up and maintaining a wired or wireless connection with an interface of a different communication device of communication system 700, as well as radio interface 727 for setting up and maintaining at least wireless connection 770 with UE 730 located in a coverage area (not shown in FIG. 11) served by base station 720. Communication interface 726 may be configured to facilitate connection 760 to host computer 710. Connection 760 may be direct or it may pass through a core network (not shown in FIG. 11) of the telecommunication system and/or through one or more intermediate networks outside the telecommunication system. In the embodiment shown, hardware 725 of base station 720 further includes processing circuitry 728, which may comprise one or more programmable processors, application-specific integrated circuits, field programmable gate arrays or combinations of these (not shown) adapted to execute instructions. Base station 720 further has software 721 stored internally or accessible via an external connection.

Communication system 700 further includes UE 730 already referred to. Its hardware 735 may include radio interface 737 configured to set up and maintain wireless connection 770 with a base station serving a coverage area in which UE 730 is currently located. Hardware 735 of UE 730 further includes processing circuitry 738, which may comprise one or more programmable processors, application-specific integrated circuits, field programmable gate arrays or combinations of these (not shown) adapted to execute instructions. UE 730 further comprises software 731, which is stored in or accessible by UE 730 and executable by processing circuitry 738. Software 731 includes client application 732. Client application 732 may be operable to provide a service to a human or non-human user via UE 730, with the support of host computer 710. In host computer 710, an executing host application 712 may communicate with the executing client application 732 via OTT connection 750 terminating at UE 730 and host computer 710. In providing the service to the user, client application 732 may receive request data from host application 712 and provide user data in response to the request data. OTT connection 750 may transfer both the request data and the user data. Client application 732 may interact with the user to generate the user data that it provides.

It is noted that host computer 710, base station 720 and UE 730 illustrated in FIG. 11 may be similar or identical to host computer 730, one of base stations 612a, 612b, 612c and one of UEs 691, 692 of FIG. 10, respectively. This is to say, the inner workings of these entities may be as shown in FIG. 10 and independently, the surrounding network topology may be that of FIG. 10.

In FIG. 11, OTT connection 750 has been drawn abstractly to illustrate the communication between host computer 710 and UE 730 via base station 720, without explicit reference to any intermediary devices and the precise routing of messages via these devices. Network infrastructure may determine the routing, which it may be configured to hide from UE 730 or from the service provider operating host computer 710, or both. While OTT connection 750 is active, the network infrastructure may further take decisions by which it dynamically changes the routing (e.g., on the basis of load balancing consideration or reconfiguration of the network).

Wireless connection 770 between UE 730 and base station 720 is in accordance with the teachings of the embodiments described throughout this disclosure. One or more of the various embodiments improve the performance of OTT services provided to UE 730 using OTT connection 750, in which wireless connection 770 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 750 between host computer 710 and UE 730, in response to variations in the measurement results. The measurement procedure and/or the network functionality for reconfiguring OTT connection 750 may be implemented in software 711 and hardware 715 of host computer 710 or in software 731 and hardware 735 of UE 730, or both. In embodiments, sensors (not shown) may be deployed in or in association with communication devices through which OTT connection 750 passes; the sensors may participate in the measurement procedure by supplying values of the monitored quantities exemplified above or supplying values of other physical quantities from which software 711, 731 may compute or estimate the monitored quantities. The reconfiguring of OTT connection 750 may include message format, retransmission settings, preferred routing etc.; the reconfiguring need not affect base station 720, and it may be unknown or imperceptible to base station 720. Such procedures and functionalities may be known and practiced in the art. In certain embodiments, measurements may involve proprietary UE signaling facilitating host computer 710's measurements of throughput, propagation times, latency and the like. The measurements may be implemented in that software 711 and 731 causes messages to be transmitted, in particular empty or ‘dummy’ messages, using OTT connection 750 while it monitors propagation times, errors etc.

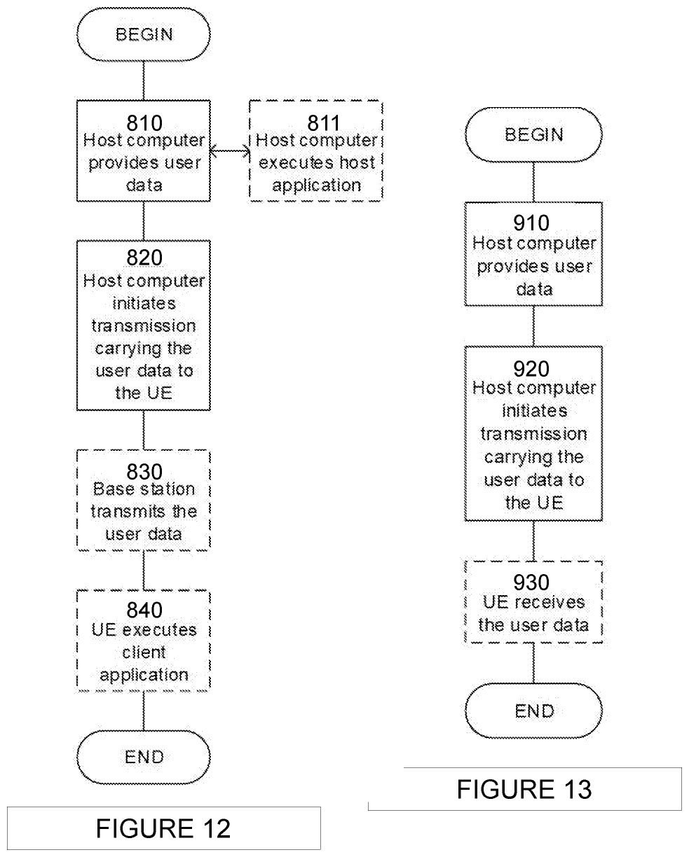

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In step 810, the host computer provides user data. In substep 811 (which may be optional) of step 810, the host computer provides the user data by executing a host application. In step 820, the host computer initiates a transmission carrying the user data to the UE. In step 830 (which may be optional), the base station transmits to the UE the user data which was carried in the transmission that the host computer initiated, in accordance with the teachings of the embodiments described throughout this disclosure. In step 840 (which may also be optional), the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In step 910 of the method, the host computer provides user data. In an optional substep (not shown) the host computer provides the user data by executing a host application. In step 920, the host computer initiates a transmission carrying the user data to the UE. The transmission may pass via the base station, in accordance with the teachings of the embodiments described throughout this disclosure. In step 930 (which may be optional), the UE receives the user data carried in the transmission.

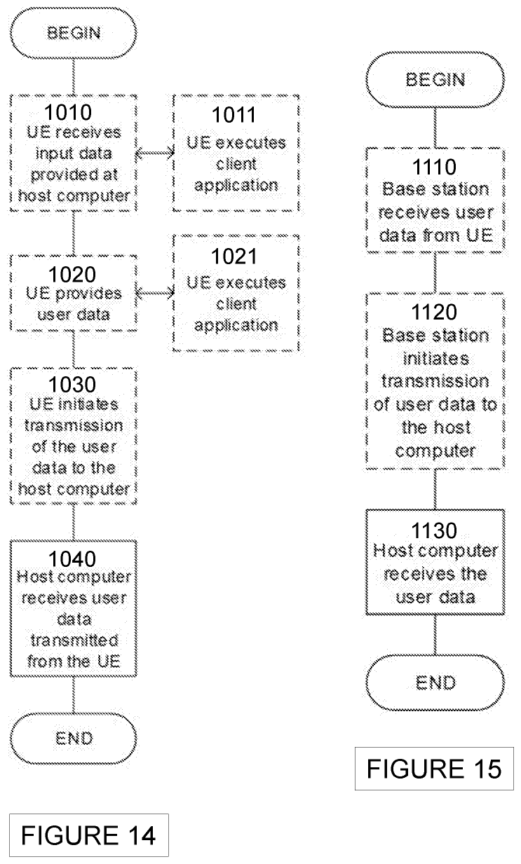

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In step 1010 (which may be optional), the UE receives input data provided by the host computer. Additionally or alternatively, in step 1020, the UE provides user data. In substep 1021 (which may be optional) of step 1020, the UE provides the user data by executing a client application. In substep 1011 (which may be optional) of step 1010, the UE executes a client application which provides the user data in reaction to the received input data provided by the host computer. In providing the user data, the executed client application may further consider user input received from the user. Regardless of the specific manner in which the user data was provided, the UE initiates, in substep 1030 (which may be optional), transmission of the user data to the host computer. In step 1040 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In step 1110 (which may be optional), in accordance with the teachings of the embodiments described throughout this disclosure, the base station receives user data from the UE. In step 1120 (which may be optional), the base station initiates transmission of the received user data to the host computer. In step 1130 (which may be optional), the host computer receives the user data carried in the transmission initiated by the base station.

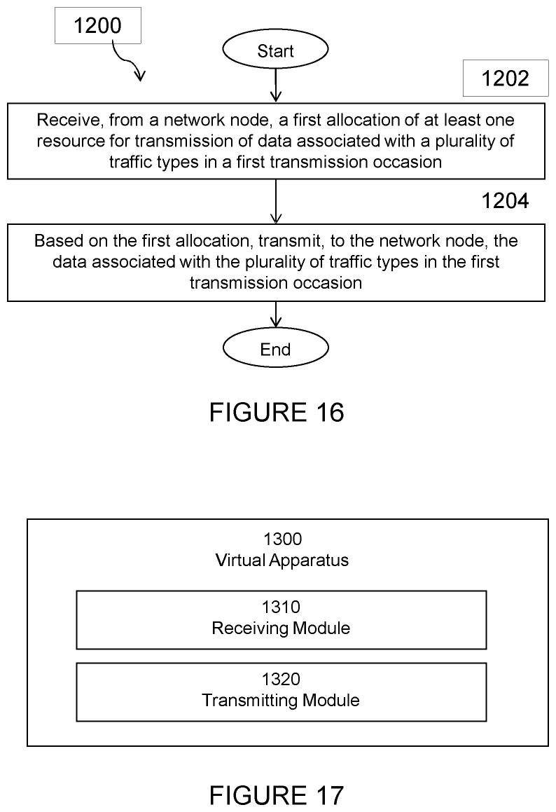

FIG. 16 depicts a method 1200 by a wireless device 310 for using an allocation of resources for transmission of multiple traffic types, according to certain embodiments. At step 1202, the wireless device 310 receives, from a network node, a first allocation of at least one resource for transmission of data associated with a plurality of traffic types in a first transmission occasion. Based on the first allocation, the wireless device 310 transmits, to the network node 360, the data associated with the plurality of traffic types in the first transmission occasion, at step 1204.

In a particular embodiment, the first allocation of the at least one resource is associated with a configured grant for transmission on an uplink to the network node.

In a particular embodiment, the plurality of traffic types include a first traffic type associated with a first service, and a second traffic type associated with a second service.

In a particular embodiment, the first and second services are each selected from: URLLC; eMBB; TSN; VOIP; and XR.

In a particular embodiment, at least one of the following is fulfilled: the first traffic type and the second traffic type are associated with different MAC priority levels; the first traffic type and the second traffic type are associated with different PHY priority levels; the first traffic type and the second traffic type are associated with different packet arrival periodicities; the first traffic type and the second traffic type are associated with different packet sizes; the first traffic type and the second traffic type are associated with different traffic origin sources; the first traffic type and the second traffic type are associated with different application contexts or application sources; the first traffic type and the second traffic type are associated with different encoding parameters; and the first traffic type and the second traffic type are associated with different quality of service targets.

In a particular embodiment, based on the first allocation, the wireless device 310 determines a first portion of the first transmission occasion for allocation to the first traffic type. Based on the first allocation, the wireless device 310 determines a second portion of the first transmission occasion for allocation to the second traffic type.

In a particular embodiment, the first portion is determined based on a priority level of the first traffic type, and the second portion is determined based on a priority level of the second traffic type.

In a particular embodiment, the first allocation indicates the priority level of the first traffic type and the priority level of the second traffic type.

In a particular embodiment, the first resource allocation indicates at least one value associated with the first portion and at least one value associated with the second portion.

In a particular embodiment, the first resource allocation indicates: a minimum number of symbols and/or a maximum number of symbols to be used the first traffic type; and a minimum number of symbols and/or a maximum number of symbols to be used for the second traffic type.

In a particular embodiment, the first allocation comprises an indication that the wireless device is allowed to autonomously change the at least one value associated with the first portion and the at least one value associated with the second portion.

In a particular embodiment, the first resource allocation indicates a total number of symbols in the first transmission occasion, and the wireless device 310 determines a value associated with the first portion and a value associated with the second portion based on the total number of symbols indicated in the first resource allocation.

In a particular embodiment, the wireless device 310 transmits, to the network node 360, UCI comprising: the first value selected by the wireless device for the first portion including the first traffic type in the first transmission occasion, and the second value selected by the wireless device for the second portion including the second traffic type in the first transmission occasion.

In a particular embodiment, the UCI includes a first encoding parameter for the first traffic type and a second encoding parameter for the second traffic type.

In a particular embodiment, the first value associated with the first portion is determined based on the first traffic type, and the second value associated with the second portion is determined based on the second traffic type.

In a particular embodiment, the data associated with the plurality of traffic types is transmitted in a single transport block during the first transmission occasion.

In a particular embodiment, the wireless device 310 transmits, to the network node 360, UCI requesting or indicating a new allocation of the at least one resource for transmission of the data associated with the plurality of traffic types in at least one additional transmission occasion.

In a particular embodiment, the UCI is included in the transmission of the data associated with the plurality of traffic types in the first transmission occasion.

In a particular embodiment, the UCI indicates: a first portion of the at least one resource for allocation to the first traffic type for the at least one additional transmission occasion; and a second portion of the at least one resource for allocation to the second traffic type for the at least one additional transmission occasion.

In a particular embodiment, the UCI indicates a number of transmission occasions for which the new allocation will apply.

In a particular embodiment, the wireless device 310 receives, from a network node 360, a second allocation of at least one resource for transmission of data associated with the plurality of traffic types in at least a second transmission occasion. The second allocation is different from the first allocation.

In a particular embodiment, a resource size of the first transmission occasion and a resource size of the second transmission occasion are the same. As used herein, the resource size may refer to a total number of symbols allocated to the first transmission occasion, in certain particular embodiments.

In a particular embodiment, the second allocation is received in DCI.

In a particular embodiment, the wireless device 310 transmits data associated with the plurality of traffic types according to the second resource allocation for a predetermined number of transmission occasions or for a predetermined amount of time. The wireless device 310 switches back to the first allocation after the predetermined number of transmission occasions or after the predetermined amount of time has passed.

In a particular embodiment, the second resource allocation indicates the predetermined number of transmission occasions or the predetermined amount of time.

FIG. 17 illustrates a schematic block diagram of a virtual apparatus 1300 in a wireless network (for example, the wireless network shown in FIG. 5). The apparatus may be implemented in a wireless device or network node (e.g., wireless device 310 or network node 360 shown in FIG. 5). Apparatus 1300 is operable to carry out the example method described with reference to FIG. 16 and possibly any other processes or methods disclosed herein. It is also to be understood that the method of FIG. 16 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving module 1310, transmitting module 1320, and any other suitable units of apparatus 1300 to perform corresponding functions according one or more embodiments of the present disclosure.

According to certain embodiments, receiving module 1310 may perform certain of the receiving functions of the apparatus 1300. For example, receiving module 1310 may receive, from a network node 360, a first allocation of at least one resource for transmission of data associated with a plurality of traffic types in a first transmission occasion.

According to certain embodiments, transmitting module 1320 may perform certain of the transmitting functions of the apparatus 1300. For example, based on the first allocation, transmitting module 1320 may transmits, to the network node 360, the data associated with the plurality of traffic types in the first transmission occasion.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

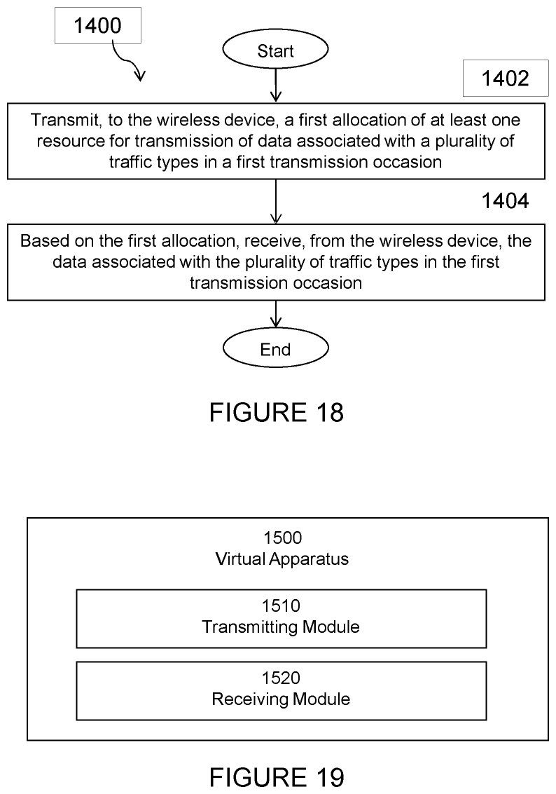

FIG. 18 depicts a method 1400 by a network node 360 for providing an allocation of resources for transmission of multiple traffic types by a wireless device 310, according to certain embodiments. At step 1402, the network node 360 transmits, to the wireless device 310, a first allocation of at least one resource for transmission of data associated with a plurality of traffic types in a first transmission occasion. Based on the first allocation, the network node 360 receives, from the wireless device 310, the data associated with the plurality of traffic types in the first transmission occasion.

In a particular embodiment, the first allocation of the at least one resource is associated with a configured grant for transmission on an uplink to the network node.

In a particular embodiment, the plurality of traffic types include a first traffic type associated with a first service and a second traffic type associated with a second service.

In a particular embodiment, the first and second services being each selected from: URLLC, eMBB, TSN, VOIP, and XR.

In a particular embodiment, at least one of the following is fulfilled: the first traffic type and the second traffic type are associated with different MAC priority levels; the first traffic type and the second traffic type are associated with different PHY priority levels; the first traffic type and the second traffic type are associated with different packet arrival periodicities; the first traffic type and the second traffic type are associated with different packet sizes; the first traffic type and the second traffic type are associated with different traffic origin sources; the first traffic type and the second traffic type are associated with different application contexts or application sources; the first traffic type and the second traffic type are associated with different encoding parameters; and the first traffic type and the second traffic type are associated with different quality of service targets.

In a particular embodiment, the first allocation includes an indication of a first portion of the first transmission occasion for allocation to the first traffic type and an indication of a second portion of the first transmission occasion for allocation to the second traffic type.

In a particular embodiment, the first portion is determined based on a priority level of the first traffic type and the second portion is determined based on a priority level of the second traffic type.

In a particular embodiment, the first allocation indicates the priority level of the first traffic type and the priority level of the second traffic type.

In a particular embodiment, the first resource allocation indicates at least one value associated with the first portion and at least one value associated with the second portion.

In a particular embodiment, the first resource allocation indicates: a minimum number of symbols and/or a maximum number of symbols to be used the first traffic type; and a minimum number of symbols and/or a maximum number of symbols to be used for the second traffic type.

In a particular embodiment, the first allocation comprises an indication that the wireless device 310 is allowed to autonomously change the at least one value associated with the first portion and the at least one value associated with the second portion.

In a particular embodiment, the first resource allocation indicates a total number of symbols in the first transmission occasion, and the method includes determining a value associated with the first portion and a value associated with the second portion based on the total number of symbols indicated in the first resource allocation.

In a particular embodiment, the network node 360 receives, from the wireless device 310, UCI comprising: the first value selected by the wireless device for the first portion including the first traffic type in the first transmission occasion, and the second value selected by the wireless device for the second portion including the second traffic type in the first transmission occasion.

In a particular embodiment, the UCI includes a first encoding parameter for the first traffic type, and a second encoding parameter for the second traffic type.

In a particular embodiment, the first value associated with the first portion is determined based on the first traffic type, and the second value associated with the second portion is determined based on the second traffic type.

In a particular embodiment, the data associated with the plurality of traffic types is received in a single transport block during the first transmission occasion.

In a particular embodiment, the network node 360 receives, from the wireless device 110, UCI requesting or indicating a new allocation of the at least one resource for transmission of the data associated with the plurality of traffic types in at least one additional transmission occasion.

In a particular embodiment, the UCI is included in the transmission of the data associated with the plurality of traffic types in the first transmission occasion.

In a particular embodiment, the UCI indicates: a first portion of the at least one resource for allocation to the first traffic type for the at least one additional transmission occasion; and a second portion of the at least one resource for allocation to the second traffic type for the at least one additional transmission occasion.

In a particular embodiment, the UCI indicates a number of transmission occasions for which the new allocation will apply.

In a particular embodiment, the network node 360 transmits, to the wireless device 310, a second allocation of at least one resource for transmission of data associated with the plurality of traffic types in at least a second transmission occasion, wherein the second allocation is different from the first allocation.

In a particular embodiment, a resource size of the first transmission occasion and a resource size of the second transmission occasion are the same.

In a particular embodiment, the second allocation is transmitted in DCI.

In a particular embodiment, the network node 360 receives data associated with the plurality of traffic types according to the second resource allocation for a predetermined number of transmission occasions or for a predetermined amount of time.

In a particular embodiment, the second resource allocation indicates the predetermined number of transmission occasions or the predetermined amount of time.

In a particular embodiment, the network node comprises a gNodeB (gNB).

FIG. 19 illustrates a schematic block diagram of a virtual apparatus 1500 in a wireless network (for example, the wireless network shown in FIG. 5). The apparatus may be implemented in a wireless device or network node (e.g., wireless device 310 or network node 360 shown in FIG. 5). Apparatus 1500 is operable to carry out the example method described with reference to FIG. 18 and possibly any other processes or methods disclosed herein. It is also to be understood that the method of FIG. 18 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1510, receiving module 1520, and any other suitable units of apparatus 1500 to perform corresponding functions according one or more embodiments of the present disclosure.

According to certain embodiments, transmitting module 1510 may perform certain of the transmitting functions of the apparatus 1500. For example, transmitting module 1510 may transmit, to the wireless device 310, a first allocation of at least one resource for transmission of data associated with a plurality of traffic types in a first transmission occasion.

According to certain embodiments, receiving module 1520 may perform certain of the receiving functions of the apparatus 1500. For example, based on the first allocation, receiving module 1520 may receive, from the wireless device 310, the data associated with the plurality of traffic types in the first transmission occasion.

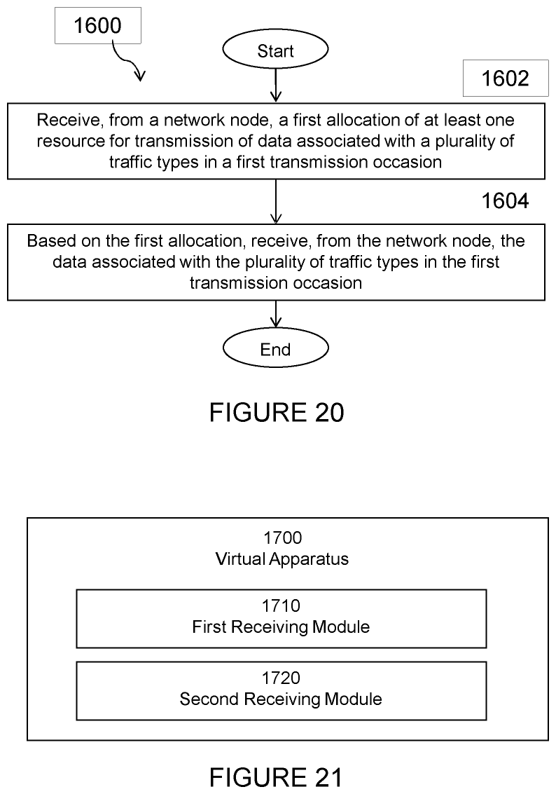

FIG. 20 depicts another method 1600 by a wireless device 310 for using an allocation of resources for reception of multiple traffic types, according to certain embodiments. At step 1602, the wireless device 310 receives, from a network node 360, a first allocation of at least one resource for transmission of data associated with a plurality of traffic types in a first transmission occasion. Based on the first allocation, the wireless device 310 receives, from the network node 360, the data associated with the plurality of traffic types in the first transmission occasion.

In a particular embodiment, the first allocation of the at least one resource is associated with SPS for receiving at least one transmission on a downlink from the network node.

In a particular embodiment, the plurality of traffic types comprise: a first traffic type associated with a first service, and a second traffic type associated with a second service.

In a particular embodiment, the first and second services being each selected from: URLLC, eMBB, TSN, VOIP, and XR.

In a particular embodiment, at least one of the following is fulfilled: the first traffic type and the second traffic type are associated with different MAC priority levels; the first traffic type and the second traffic type are associated with different PHY priority levels; the first traffic type and the second traffic type are associated with different packet arrival periodicities; the first traffic type and the second traffic type are associated with different packet sizes; the first traffic type and the second traffic type are associated with different traffic origin sources; the first traffic type and the second traffic type are associated with different application contexts or application sources; the first traffic type and the second traffic type are associated with different encoding parameters; and the first traffic type and the second traffic type are associated with different quality of service targets.

In a particular embodiment, based on the first allocation, the wireless device 310 determines a first portion of the first transmission occasion as being allocated to the first traffic type. Based on the first allocation, the wireless device 310 determines a second portion of the first transmission occasion as being allocated to the second traffic type.

In a particular embodiment, the first portion is determined based on a priority level of the first traffic type, and the second portion is determined based on a priority level of the second traffic type.

In a particular embodiment, the first allocation indicates the priority level of the first traffic type and the priority level of the second traffic type.

In a particular embodiment, the first resource allocation indicates at least one value associated with the first portion and at least one value associated with the second portion.

In a particular embodiment, the first resource allocation indicates: a minimum number of symbols and/or a maximum number of symbols to be used the first traffic type and a minimum number of symbols and/or a maximum number of symbols to be used for the second traffic type.

In a particular embodiment, the first allocation comprises an indication that the wireless device 310 is allowed to autonomously change the at least one value associated with the first portion and the at least one value associated with the second portion.

In a particular embodiment, the first resource allocation indicates a total number of symbols in the first transmission occasion, and a value associated with the first portion and a value associated with the second portion are determined based on the total number of symbols indicated in the first resource allocation.

In a particular embodiment, the wireless device 310 transmits, to the network node 360, UCI including: the first value selected by the wireless device for the first portion including the first traffic type in the first transmission occasion, and the second value selected by the wireless device for the second portion including the second traffic type in the first transmission occasion.

In a particular embodiment, the UCI comprises: a first encoding parameter for the first traffic type, and a second encoding parameter for the second traffic type.

In a particular embodiment, the first value associated with the first portion is determined based on the first traffic type, and the second value associated with the second portion is determined based on the second traffic type.

In a particular embodiment, the data associated with the plurality of traffic types is received in a single transport block during the first transmission occasion.

In a particular embodiment, the wireless device 310 transmits, to the network node 160, UCI requesting or indicating a new allocation of the at least one resource for transmission of the data associated with the plurality of traffic types in at least one additional transmission occasion.

In a particular embodiment, the UCI is included in the transmission of the data associated with the plurality of traffic types in the first transmission occasion.

In a particular embodiment, the UCI indicates: a first portion of the at least one resource for allocation to the first traffic type for the at least one additional transmission occasion; and a second portion of the at least one resource for allocation to the second traffic type for the at least one additional transmission occasion.

In a particular embodiment, the UCI indicates a number of transmission occasions for which the new allocation will apply.

In a particular embodiment, the wireless device 310 receives, from a network node 360, a second allocation of at least one resource for transmission of data associated with the plurality of traffic types in at least a second transmission occasion, wherein the second allocation is different from the first allocation.

In a particular embodiment, a resource size of the first transmission occasion and a resource size of the second transmission occasion are the same.

In a particular embodiment, the second allocation is received in DCI.

In a particular embodiment, the wireless device 310 receives data associated with the plurality of traffic types according to the second resource allocation for a predetermined number of transmission occasions or for a predetermined amount of time. The wireless device 310 switches back to the first allocation after the predetermined number of transmission occasions or after the predetermined amount of time has passed.

In a particular embodiment, the second resource allocation indicates the predetermined number of transmission occasions or the predetermined amount of time.

FIG. 21 illustrates a schematic block diagram of a virtual apparatus 1700 in a wireless network (for example, the wireless network shown in FIG. 5). The apparatus may be implemented in a wireless device or network node (e.g., wireless device 310 or network node 360 shown in FIG. 5). Apparatus 1700 is operable to carry out the example method described with reference to FIG. 20 and possibly any other processes or methods disclosed herein. It is also to be understood that the method of FIG. 20 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first receiving module 1710, second receiving module 1720, and any other suitable units of apparatus 1700 to perform corresponding functions according one or more embodiments of the present disclosure.

According to certain embodiments, first receiving module 1710 may perform certain of the receiving functions of the apparatus 1700. For example, first receiving module 1710 may receive, from a network node 360, a first allocation of at least one resource for transmission of data associated with a plurality of traffic types in a first transmission occasion.

According to certain embodiments, second receiving module 1720 may perform certain other of the receiving functions of the apparatus 1700. For example, based on the first allocation, second receiving module 1720 may receive, from the network node 360, the data associated with the plurality of traffic types in the first transmission occasion.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

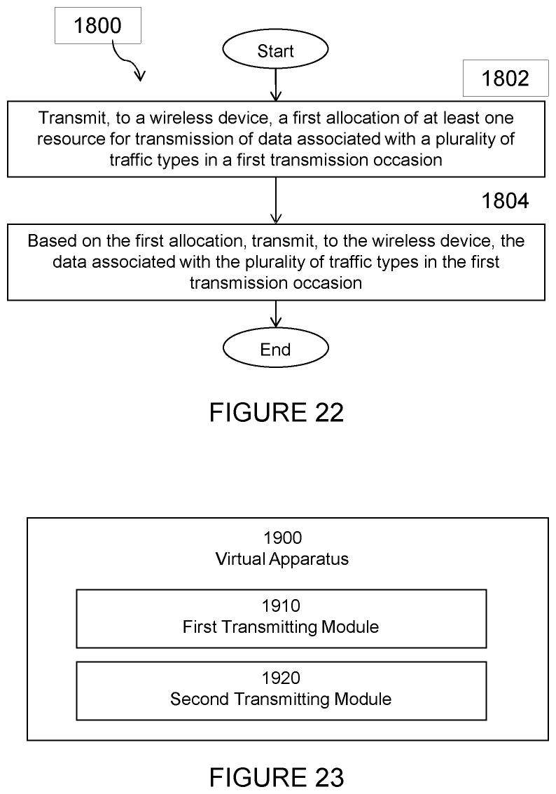

FIG. 22 depicts another method 1800 by a network node 360 for using an allocation of resources for transmission of multiple traffic types, according to certain embodiments. At step 1802, the network node 360 transmits, to a wireless device, a first allocation of at least one resource for transmission of data associated with a plurality of traffic types in a first transmission occasion. Based on the first allocation, the network node 360 transmits, to the wireless device 310, the data associated with the plurality of traffic types in the first transmission occasion.

In a particular embodiment, the first allocation of the at least one resource is associated with SPS for transmission on a downlink from the network node to the wireless device.

In a particular embodiment, the plurality of traffic types a comprise: a first traffic type associated with a first service, and a second traffic type associated with a second service.

In a particular embodiment, the first and second services are each selected from: URLLC, eMBB, TSN, VOIP, and XR.

In a particular embodiment, at least one of the following is fulfilled: the first traffic type and the second traffic type are associated with different MAC priority levels; the first traffic type and the second traffic type are associated with different PHY priority levels; the first traffic type and the second traffic type are associated with different packet arrival periodicities; the first traffic type and the second traffic type are associated with different packet sizes; the first traffic type and the second traffic type are associated with different traffic origin sources; the first traffic type and the second traffic type are associated with different application contexts or application sources; the first traffic type and the second traffic type are associated with different encoding parameters; and the first traffic type and the second traffic type are associated with different quality of service targets.

In a particular embodiment, based on the first allocation, the network node 360 determines a first portion of the first transmission occasion as being allocated to the first traffic type. Based on the first allocation, the network node 360 determines a second portion of the first transmission occasion as being allocated to the second traffic type.

In a particular embodiment, the first portion is determined based on a priority level of the first traffic type, and the second portion is determined based on a priority level of the second traffic type.

In a particular embodiment, the first allocation indicates the priority level of the first traffic type and the priority level of the second traffic type.

In a particular embodiment, the first resource allocation indicates at least one value associated with the first portion and at least one value associated with the second portion.

In a particular embodiment, the first resource allocation indicates: a minimum number of symbols and/or a maximum number of symbols to be used the first traffic type; and a minimum number of symbols and/or a maximum number of symbols to be used for the second traffic type.

In a particular embodiment, the first allocation comprises an indication that the wireless device is allowed to autonomously change the at least one value associated with the first portion and the at least one value associated with the second portion.

In a particular embodiment, the first resource allocation indicates a total number of symbols in the first transmission occasion, and a value associated with the first portion and a value associated with the second portion are determined based on the total number of symbols indicated in the first resource allocation.

In a particular embodiment, the network node 360 receives, from the wireless device, UCI including: the first value selected by the wireless device for the first portion including the first traffic type in the first transmission occasion, and the second value selected by the wireless device for the second portion including the second traffic type in the first transmission occasion.

In a particular embodiment, the UCI includes a first encoding parameter for the first traffic type, and a second encoding parameter for the second traffic type.

In a particular embodiment, the first value associated with the first portion is determined based on the first traffic type, and the second value associated with the second portion is determined based on the second traffic type.

In a particular embodiment, the data associated with the plurality of traffic types is transmitted in a single transport block during the first transmission occasion.

In a particular embodiment, the network node 360 receives, from the wireless device 310, UCI requesting or indicating a new allocation of the at least one resource for transmission of the data associated with the plurality of traffic types in at least one additional transmission occasion.

In a particular embodiment, the UCI is included in the transmission of the data associated with the plurality of traffic types in the first transmission occasion.

In a particular embodiment, the UCI indicates: a first portion of the at least one resource for allocation to the first traffic type for the at least one additional transmission occasion; and a second portion of the at least one resource for allocation to the second traffic type for the at least one additional transmission occasion.

In a particular embodiment, the UCI indicates a number of transmission occasions for which the new allocation will apply.

In a particular embodiment, the network node 360 transmits, to the wireless device 310, a second allocation of at least one resource for transmission of data associated with the plurality of traffic types in at least a second transmission occasion, wherein the second allocation is different from the first allocation.

In a particular embodiment, a resource size of the first transmission occasion and a resource size of the second transmission occasion are the same.

In a particular embodiment, the second allocation is transmitted in DCI.106.

In a particular embodiment, the network node 360 transmits data associated with the plurality of traffic types according to the second resource allocation for a predetermined number of transmission occasions or for a predetermined amount of time, and switches back to the first allocation after the predetermined number of transmission occasions or after the predetermined amount of time has passed.

In a particular embodiment, the second resource allocation indicates the predetermined number of transmission occasions or the predetermined amount of time.

FIG. 23 illustrates a schematic block diagram of a virtual apparatus 1900 in a wireless network (for example, the wireless network shown in FIG. 5). The apparatus may be implemented in a wireless device or network node (e.g., wireless device 310 or network node 360 shown in FIG. 5). Apparatus 1900 is operable to carry out the example method described with reference to FIG. 22 and possibly any other processes or methods disclosed herein. It is also to be understood that the method of FIG. 22 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first transmitting module 1910, second transmitting module 1920, and any other suitable units of apparatus 1900 to perform corresponding functions according one or more embodiments of the present disclosure.

According to certain embodiments, first transmitting module 1910 may perform certain of the transmitting functions of the apparatus 1900. For example, first transmitting module 1910 may transmit, to a wireless device 310, a first allocation of at least one resource for transmission of data associated with a plurality of traffic types in a first transmission occasion.

According to certain embodiments, second receiving module 1920 may perform certain other of the receiving functions of the apparatus 1900. For example, based on the first allocation, second transmitting module 1920 may transmit, to the wireless device 310, the data associated with the plurality of traffic types in the first transmission occasion.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a wireless device for using an allocation of resources for transmission of multiple traffic types, the method comprising:
receiving, from a network node, a first allocation of at least one resource for transmission of data associated with a plurality of traffic types in a first transmission occasion; and
based on the first allocation, transmitting, to the network node, the data associated with the plurality of traffic types in the first transmission occasion, wherein the first allocation of the at least one resource is associated with a configured grant for transmission on an uplink to the network node.

2. (canceled)

3. The method of claim 1, wherein the plurality of traffic types comprise:
a first traffic type associated with a first service, and
a second traffic type associated with a second service.

4. The method of claim 3, wherein the first and second services being each selected from:
Ultra-Reliable Low-Latency Communication (URLLC);
Enhanced Mobile Broadband (eMBB);
Time Sensitive Networking (TSN);
Voice over IP (VOIP); and
Extended Reality (XR).

5. The method of claim 3, wherein at least one of:
the first traffic type and the second traffic type are associated with different Medium Access Control (MAC) priority levels;
the first traffic type and the second traffic type are associated with different physical layer (PHY) priority levels;
the first traffic type and the second traffic type are associated with different packet arrival periodicities;
the first traffic type and the second traffic type are associated with different packet sizes;
the first traffic type and the second traffic type are associated with different traffic origin sources;
the first traffic type and the second traffic type are associated with different application contexts or application sources;
the first traffic type and the second traffic type are associated with different encoding parameters; and
the first traffic type and the second traffic type are associated with different quality of service targets.

6. The method of claim 3, wherein the method further comprises:
based on the first allocation, determining a first portion of the first transmission occasion for allocation to the first traffic type; and
based on the first allocation, determining a second portion of the first transmission occasion for allocation to the second traffic type.

7. The method of claim 6, wherein:
the first portion is determined based on a priority level of the first traffic type; and
the second portion is determined based on a priority level of the second traffic type, wherein the first allocation indicates the priority level of the first traffic type and the priority level of the second traffic type.

8. (canceled)

9. The method of claim 6, wherein the first allocation indicates at least one value associated with the first portion and at least one value associated with the second portion.

10. The method of claim 9, wherein the first allocation indicates:
a minimum number of symbols and/or a maximum number of symbols to be used the first traffic type; and
a minimum number of symbols and/or a maximum number of symbols to be used for the second traffic type.

11. The method of claim 9, wherein the first allocation comprises an indication that the wireless device is allowed to autonomously change the at least one value associated with the first portion and the at least one value associated with the second portion.

12. The method of claim 6, wherein the first allocation indicates a total number of symbols in the first transmission occasion, and the method comprises:
determining a value associated with the first portion and a value associated with the second portion based on the total number of symbols indicated in the first resource allocation.

13. The method of claim 11, further comprising transmitting, to the network node, uplink control information (UCI) comprising:
the first value selected by the wireless device for the first portion including the first traffic type in the first transmission occasion,
the second value selected by the wireless device for the second portion including the second traffic type in the first transmission occasion,
a first encoding parameter for the first traffic type, and
a second encoding parameter for the second traffic type.

14. (canceled)

15. The method of claim 9, wherein:
the first value associated with the first portion is determined based on the first traffic type, and
the second value associated with the second portion is determined based on the second traffic type.

16. The method of claim 1, wherein the data associated with the plurality of traffic types is transmitted in a single transport block during the first transmission occasion.

17. The method of claim 1, further comprising transmitting, to the network node, uplink control information (UCI) requesting or indicating a new allocation of the at least one resource for transmission of the data associated with the plurality of traffic types in at least one additional transmission occasion.

18. The method of claim 17, wherein the UCI is included in the transmission of the data associated with the plurality of traffic types in the first transmission occasion, wherein the UCI indicates:
a first portion of the at least one resource for allocation to a first traffic type for the at least one additional transmission occasion; and
a second portion of the at least one resource for allocation to a second traffic type for the at least one additional transmission occasion.

19. (canceled)

20. The method of claim 17, wherein the UCI indicates a number of transmission occasions for which the new allocation will apply.

21. The method of claim 1, further comprising:
receiving, from a network node, a second allocation of at least one resource for transmission of data associated with the plurality of traffic types in at least a second transmission occasion, wherein the second allocation is different from the first allocation.

22-25. (canceled)

26. A wireless device for using an allocation of resources for transmission of multiple traffic types, the wireless device comprising processing circuitry configured to:
receive, from a network node, a first allocation of at least one resource for transmission of data associated with a plurality of traffic types in a first transmission occasion; and
based on the first allocation, transmit, to the network node, the data associated with the plurality of traffic types in the first transmission occasion, wherein the first allocation of the at least one resource is associated with a configured grant for transmission on an uplink to the network node.

27. (canceled)

28. A method by a network node for providing an allocation of resources for transmission of multiple traffic types by a wireless device, the method comprising:
transmitting, to the wireless device, a first allocation of at least one resource for transmission of data associated with a plurality of traffic types in a first transmission occasion; and
based on the first allocation, receiving, from the wireless device, the data associated with the plurality of traffic types in the first transmission occasion, wherein the first allocation of the at least one resource is associated with a configured grant for transmission on an uplink to the network node.

29-109. (canceled)
